(19) United States
(12) Patent Application Publication
(10) Pub. No.: US 2024/0348465 A1
(43) Pub. Date: Oct. 17, 2024

(54) INFORMATION PROCESSING DEVICE, INFORMATION PROCESSING METHOD, AND PROGRAM

(71) Applicant: Sony Group Corporation, Tokyo (JP)

(72) Inventors: Hikaru TAKATORI, Chiba (JP); Ryusei KOIKE, Kanagawa (JP); Yoshihiro TAMURA, Kanagawa (JP); Yusuke SAKAI, Kanagawa (JP); Kazuko YAMADA, Tokyo (JP)

(73) Assignee: Sony Group Corporation, Tokyo (JP)

(21) Appl. No.: 18/682,511

(22) PCT Filed: Mar. 2, 2022
(86) PCT No.: PCT/JP2022/008814

§ 371 Date: Feb. 9, 2024

(30) Foreign Application Priority Data
Aug. 17, 2021 (JP) 2021-132992

(51) Int. Cl. H04L 12/18; G06F 3/14; G09B 5/06

(52) U.S. Cl. CPC H04L 12/1813; G06F 3/14; G09B 5/065

(57) ABSTRACT

For example, communication between information processing terminals can be smoothly performed. Provided is an information processing device including a control unit configured to acquire information regarding a bidirectional strength based on arrangement information indicating a relationship between a plurality of information processing terminals, and perform control to change an output form in an output unit of at least one information processing terminal among the plurality of information processing terminals on the basis of the bidirectional strength.

### TECHNICAL FIELD

The present disclosure relates to an information processing device, an information processing method, and a program.

### BACKGROUND ART

A system in which voice and video are transmitted and received between a plurality of terminal devices connected to each other in a predetermined network is known (See, for example, Patent Document 1). Such a system enables live distribution and the like of a conference, a lesson, a content, and the like between remote terminals.

### CITATION LIST

### Patent Document

Patent Document 1: Japanese Patent Application Laid-Open No. 2006-140894

### SUMMARY OF THE INVENTION

### Problems to be Solved by the Invention

In this field, it is desirable to smoothly perform communication between terminals.

An object of the present disclosure is to provide an information processing device, an information processing method, and a program that enable smooth communication between terminals.

### Solutions to Problems

The present disclosure is, for example, an information processing device including a control unit configured to acquire information regarding a bidirectional strength based on arrangement information indicating a relationship between a plurality of information processing terminals, and perform control to change an output form in an output unit of at least one information processing terminal among the plurality of information processing terminals on the basis of the bidirectional strength.

The present disclosure is, for example, an information processing method including acquiring, by a control unit, information regarding a bidirectional strength based on arrangement information indicating a relationship between a plurality of information processing terminals, and performing control to change an output form in an output unit of at least one information processing terminal among the plurality of information processing terminals on the basis of the bidirectional strength.

The present disclosure is, for example, a program causing a computer to perform an information processing method including acquiring, by a control unit, information regarding a bidirectional strength based on arrangement information indicating a relationship between a plurality of information processing terminals, and performing control to change an output form in an output unit of at least one information processing terminal among the plurality of information processing terminals on the basis of the bidirectional strength.

### BRIEF DESCRIPTION OF DRAWINGS

FIG. 1 is a diagram referred to when problems to be considered in the present disclosure is described.

FIGS. 2A to 2D are diagrams referred to when problems to be considered in the present disclosure is described.

FIG. 3 illustrates a configuration example of a video communication system according to one embodiment.

FIG. 4 illustrates an external configuration example of the video communication system according to one embodiment.

FIG. 5 is a diagram referred to when an outline of one embodiment is described.

FIG. 6 is a diagram referred to when an outline of one embodiment is described.

FIG. 7 is a diagram for describing an example of a method of generating arrangement information according to one embodiment.

FIG. 8 is a diagram for describing an example of arrangement information and an arrangement position of a host terminal according to one embodiment.

FIG. 9 is a diagram for describing another example of the arrangement position of the host terminal.

FIG. 10 is a diagram for describing another example of the arrangement information.

FIG. 11 is a diagram for describing another example of the arrangement information.

FIG. 12 is a diagram for describing another example of the arrangement information.

FIG. 13 is a diagram for describing another example of the arrangement information.

FIG. 14 is a diagram for describing an example of arrangement information having another structure.

FIG. 15 is a diagram for describing an example of arrangement information having another structure.

FIG. 16 is a diagram for describing distance data according to one embodiment.

FIGS. 17A to 17E are diagrams for describing an example in which a display form of video is changed according to distance data.

FIG. 18 is a diagram for describing a changed arrangement position of the host terminal in the arrangement information.

FIGS. 19A to 19E are diagrams for describing an example in which a display form of video is changed according to distance data.

FIG. 20 is a diagram for describing an interaction target scope according to one embodiment.

FIG. 21 is a diagram for describing an interaction target scope according to one embodiment.

FIG. 22 is a diagram for describing another example of the interaction target scope.

FIGS. 23A and 23B are diagrams for describing an example of change in an output form based on a bidirectional strength.

FIGS. 24A to 24C are diagrams for describing a specific example of change in an output form based on a bidirectional strength.

FIGS. 25A to 25C are diagrams for describing a specific example of change in an output form based on a bidirectional strength.

FIGS. 26A to 26C are diagrams for describing a specific example of change in an output form based on a bidirectional strength.

FIGS. 27A to 27C are diagrams for describing a specific example of change in an output form based on a bidirectional strength.

FIG. 28 is a diagram for describing a specific example of change in an output form based on a bidirectional strength.

FIGS. 29A to 29E are diagrams for describing a specific example of change in a sound output form based on a bidirectional strength.

FIGS. 30A to 30E are diagrams for describing a specific example of change in a sound output form based on a bidirectional strength.

FIGS. 31A to 31C are diagrams for describing a specific example of change in an output form based on a bidirectional strength.

FIGS. 32A to 32C are diagrams for describing a specific example of change in an output form based on a bidirectional strength.

FIGS. 33A to 33C are diagrams for describing a specific example of change in an output form based on a bidirectional strength.

FIGS. 34A and 34B are diagrams for describing an example of processing related to a response request from the client terminal to the host terminal.

FIGS. 35A and 35B are diagrams for describing another example of the processing related to a response request from the client terminal to the host terminal.

FIG. 36 is a block diagram illustrating a configuration example of the host terminal.

FIG. 37 is a block diagram illustrating a configuration example of the client terminal.

FIG. 38 is a block diagram illustrating a configuration example of the server.

FIG. 39 is a flowchart illustrating a flow of processing of generating arrangement information according to one embodiment.

FIG. 40 is a flowchart illustrating a flow of processing performed on the host terminal side in the host-terminal arrangement position change processing according to one embodiment.

FIG. 41 is a flowchart illustrating a flow of processing performed on the server side in the host-terminal arrangement position change processing according to one embodiment.

FIG. 42 is a flowchart illustrating a flow of processing performed on the host terminal side in the host-terminal arrangement position change processing according to one embodiment.

FIG. 43 is a flowchart illustrating a flow of processing performed on the client terminal side in the host-terminal arrangement position change processing according to one embodiment.

FIG. 44 is a flowchart illustrating a flow of processing (processing performed on the host terminal side) in consideration of presence or absence of arrangement information change instruction.

FIG. 45 is a flowchart illustrating a flow of processing (processing performed on the server side) in consideration of presence or absence of arrangement information change instruction.

FIG. 46 is a flowchart illustrating a flow of processing performed on the client terminal side in response request processing according to one embodiment.

FIG. 47 is a flowchart illustrating a flow of processing performed on the server side in the response request processing according to one embodiment.

FIG. 48 is a flowchart illustrating a flow of processing performed on the host terminal side in the response request processing according to one embodiment.

FIG. 49 is a diagram for describing a modification.

### MODE FOR CARRYING OUT THE INVENTION

Hereinafter, an embodiment and the like of the present disclosure will be described with reference to the drawings. Note that the description will be given in the following order.

### Problems to be Considered in the Present Disclosure

### One Embodiment

### Modifications

An embodiment and the like described below are preferred specific examples of the present disclosure, and the content of the present disclosure is not limited to the embodiment and the like.

### Problems to be Considered in the Present Disclosure

First, problems to be considered in the present disclosure will be described below to facilitate understanding of the present disclosure.

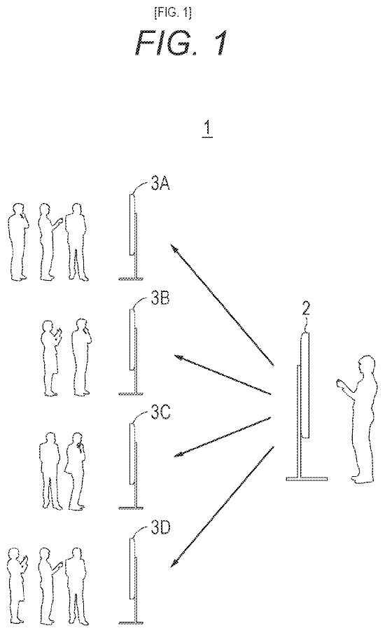

For example, a remote lesson system held between a plurality of information processing terminals is considered. FIG. 1 is a diagram schematically illustrating a remote lesson system (remote lesson system 1). The remote lesson system 1 includes, for example, a host terminal 2 and four client terminals 3A to 3D. The terminals are installed at different locations (remote locations) and connected via a network such as the Internet. Voice and video can be transmitted and received between the host terminal 2 and the client terminals 3A to 3D. The host terminal 2 is, for example, a terminal of a teacher, and the client terminals 3A to 3D are terminals of students.

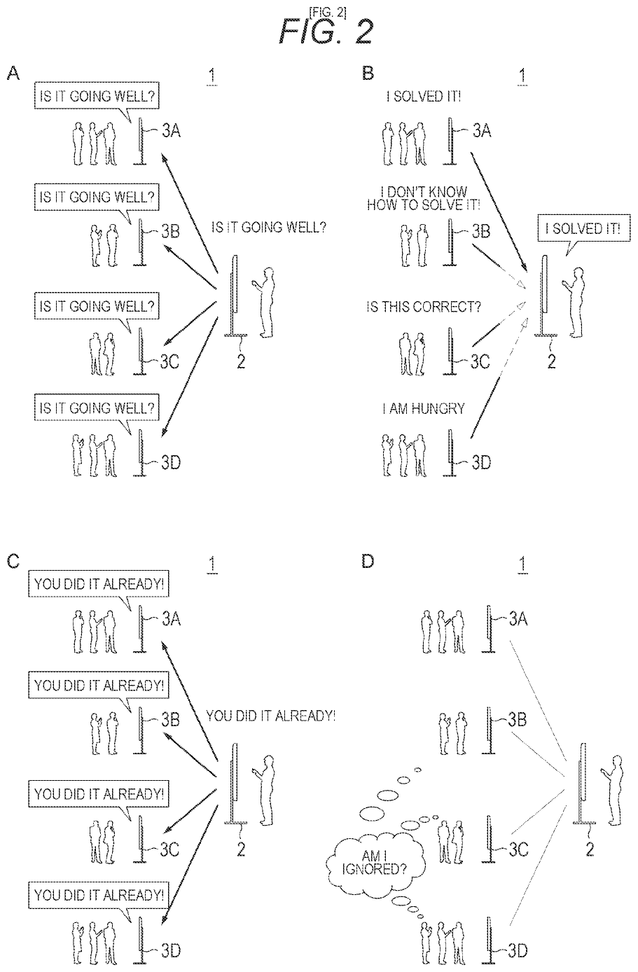

Here, a scene in which the teacher makes the students solve a problem in a remote lesson is considered. It is generally possible that a teacher utters to check the progress or the like while the students are solving the problem. For example, as illustrated in FIG. 2A, it is assumed that the teacher utters “Is it going well?”. Voice data corresponding to the utterance of the teacher is transmitted from the host terminal 2 to each of the client terminals 3A to 3D via the network, and is reproduced by each of the client terminals 3A to 3D.

A student replies to the teacher's utterance. As illustrated in FIG. 2B, for example, the student using the client terminal 3A replies “I solved it!”. Furthermore, the student using the client terminal 3B replies “I don't know how to solve it!”. Furthermore, the student using the client terminal 3C replies “Is this correct?”. Furthermore, the student using the client terminal 3D replies “I am hungry”. The voice data corresponding to the reply of each student is transmitted to the host terminal 2 via the network. It is assumed that, for example, the voice data of the student using the client terminal 3A (voice data “I solved it!”) is clearly reproduced on the host terminal 2 due to a difference in the level of the voice data, a transmission delay, selection of the utterance of the response target by the teacher, or the like.

It is assumed that the teacher utters “You did it already!” in response to the voice data reproduced by the host terminal 2 (in this example, the voice data “I solved it!”). The voice data corresponding to this utterance is supplied to each of the client terminals 3A to 3D via the network. Then, the utterance of the teacher is reproduced by each of the client terminals 3A to 3D.

The voice data reproduced by each of the client terminals 3A to 3D (in this example, the voice data corresponding to the teacher's utterance, “You did it already!”) is a response from the teacher to the student using the client terminal 3A. Therefore, the student using the client terminal 3A des not feel anything strange with the teacher's response, but the students using the client terminals 3B to 3D who have received the response that does not match their own utterance feel that their utterances have been ignored by the teacher.

As described above, there has been a possibility that smooth communication is not performed when communication is performed between the host terminal and a plurality of client terminals. Specifically, neither the user of the host terminal nor the users of the client terminals have been able to confirm to a user of which client terminal the user of the host terminal is going to communicate (for example, utter). In addition, the users of the client terminals cannot confirm whether or not the system is in a state where the user himself/herself and the user of the host terminal can communicate with each other. Moreover, the user of the host terminal has not been able to confirm a user using which client terminal is speaking or desires to speak. In view of these points, one embodiment of the present disclosure will be described in detail below.

### One Embodiment

### [Configuration Example of Video Communication System]

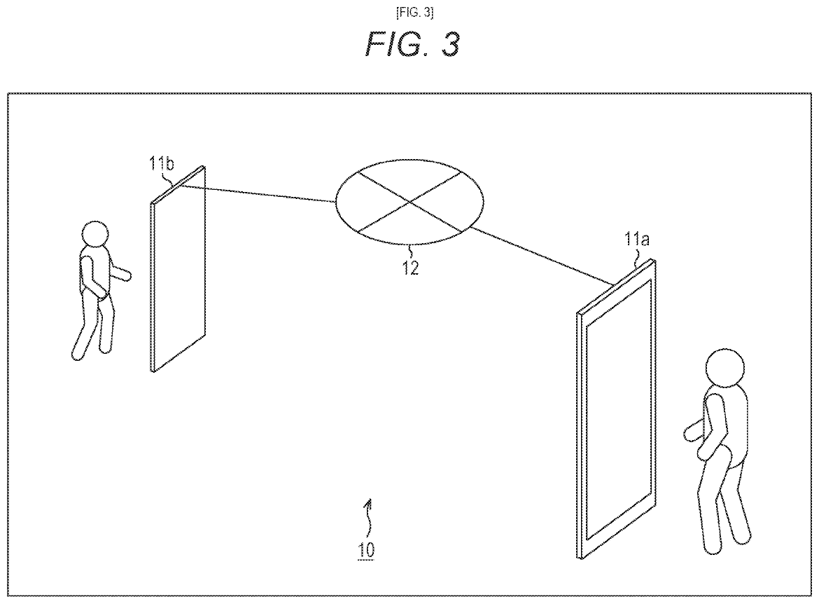

FIG. 3 illustrates a configuration example of a video communication system according to one embodiment of the present disclosure.

As illustrated in FIG. 3, the video communication system 10 is configured by connecting a telecommunication device 11a and a telecommunication device 11b as two information processing devices via a network 12 such as the Internet.

The telecommunication devices 11a and 11b are provided in different spaces such as different buildings or different rooms. A user in the vicinity of the telecommunication device 11a and a user in the vicinity of the telecommunication device 11b illustrated in FIG. 3 are users at remote locations from each other.

The telecommunication device 11a and the telecommunication device 11b basically have the same configuration. As will be described in detail later, the telecommunication device 11a and the telecommunication device 11b are each provided with, in addition to a large-sized display, a camera for imaging a surrounding state, a microphone for collecting surrounding sound such as environmental sound, a speaker for outputting sound, and the like.

Between the telecommunication device 11a and the telecommunication device 11b, transmission and reception of video captured by each camera and sound collected by each microphone are always performed in real time, for example, while connection between both the devices is established.

The telecommunication device 11a displays the video captured by the telecommunication device 11b and outputs the sound collected by the telecommunication device 11b.

The video captured by the telecommunication device 11b shows a state of a space in which the telecommunication device 11b is installed, including the figure of the user of the telecommunication device 11b. Furthermore, the sound collected by the telecommunication device 11b includes environmental sound of a space in which the telecommunication device 11b is installed, including the voice of the user of the telecommunication device 11b.

Therefore, for example, the user of the telecommunication device 11a can feel as if the user of the telecommunication device 11b is present on the opposite side of the nearby telecommunication device 11a, facing each other.

Similarly, the telecommunication device 11b displays the video captured by the telecommunication device 11a and outputs the sound collected by the telecommunication device 11a.

The video captured by the telecommunication device 11a shows a state of a space in which the telecommunication device 11a is installed, including the figure of the user of the telecommunication device 11a. Furthermore, the sound collected by the telecommunication device 11a includes environmental sound of a space in which the telecommunication device 11a is installed, including the voice of the user of the telecommunication device 11a.

Therefore, for example, the user of the telecommunication device 11b can feel as if the user of the telecommunication device 11a is present on the opposite side of the telecommunication device 11b, facing each other.

The user of the telecommunication device 11a can naturally communicate with the user of the telecommunication device 11b as if the user of the telecommunication device 11b is present in an adjacent space.

Similarly, the user of the telecommunication device 11b can naturally communicate with the user of the telecommunication device 11a as if the user of the telecommunication device 11a is present in an adjacent space.

That is, the users of the telecommunication device 11a and the telecommunication device 11b can more smoothly communicate with each other while feeling close to each other without being actively conscious of communication.

Hereinafter, in a case where it is not necessary to distinguish the telecommunication devices 11a and 11b, the telecommunication devices are collectively referred to as a telecommunication device 11 as appropriate. Other components provided in pairs will be similarly collectively referred to. Note that although two telecommunication devices are illustrated in FIG. 3, three or more telecommunication devices may be connected to each other. Among the plurality of telecommunication devices, for example, one telecommunication device is set as a host terminal, and telecommunication devices other than the host terminal are set as client terminals.

### [External Configuration Example of Telecommunication Device]

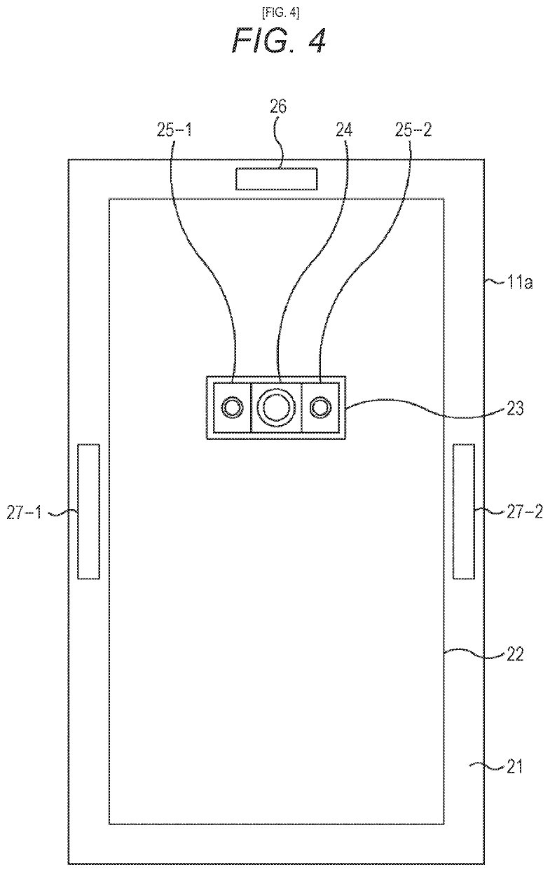

FIG. 4 is a front view illustrating an external configuration example of the telecommunication device 11a.

As illustrated in FIG. 4, a vertically long rectangular display 22 including a liquid crystal display (LCD), an organic electro luminescence (EL) display, or the like is provided on the front surface of the housing of the telecommunication device 11a while leaving a narrow frame 21.

In front of the display 22, a sensor unit 23 is provided via, for example, an indicating member (not illustrated) fixed to the frame 21. The sensor unit 23 is provided with a camera 24 and two sensors 25-1 and 25-2.

Furthermore, a microphone 26 is provided at an upper edge portion, and speakers 27-1 and 27-2 are provided at left and right edge portions, respectively, out of upper, lower, left, and right edge portions included in the frame 21.

The display 22 displays video corresponding to the video image captured by the telecommunication device 11b on the basis of the video information transmitted from the telecommunication device 11b.

The camera 24 images a space in front of the telecommunication device 11a. Video information expressing video corresponding to the captured image captured by the camera 24 is transmitted to the telecommunication device 11b.

The sensors 25-1 and 25-2 are sensors that detect the state of the user of the telecommunication device 11a. As the sensors 25-1 and 25-2, a biological sensor, a line-of-sight detection sensor, a sensor for detecting a physical operation on an operation device such as a mouse, or the like can be used.

The microphone 26 collects sound of a space where the telecommunication device 11a is installed. Sound information expressing the sound collected by the microphone 26 is transmitted to the telecommunication device 11b.

The speakers 27-1 and 27-2 output sound of the space where the telecommunication device 11b is installed on the basis of the sound information transmitted from the telecommunication device 11b.

Note that telecommunication devices other than the telecommunication device 11a such as the telecommunication device 11b have the same configuration as the configuration of the telecommunication device 11a illustrated in FIG. 4.

Furthermore, in FIG. 4, the installation positions of the camera 24, the sensors 25-1 and 25-2, the microphone 26, and the speakers 27-1 and 27-2 are an example, and they may be installed at other positions as long as the functions can be realized, and also the number of the installation positions is not limited thereto. Note that the display 22 and the speakers 27-1 and 27-2 correspond to the output units, in the present embodiment.

### Outline of Embodiment

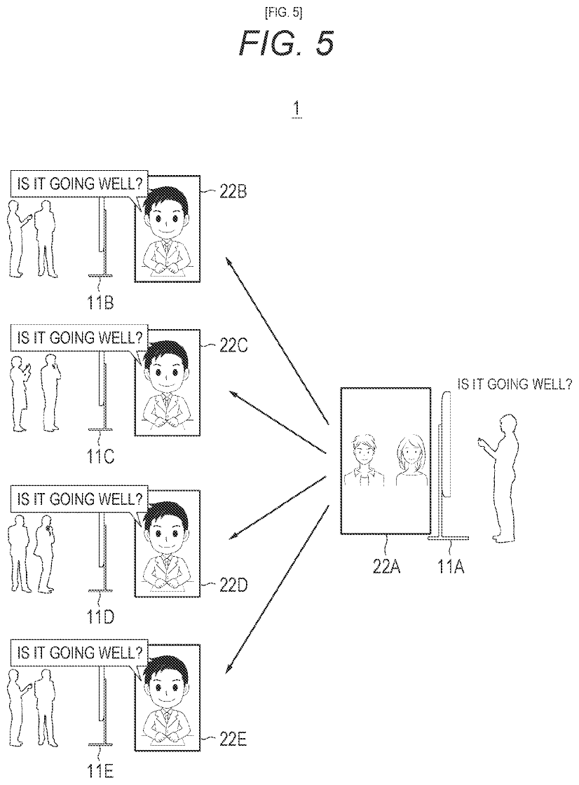

Next, in order to facilitate understanding of the present embodiment, the present embodiment will be schematically described. Hereinafter, an example in which five telecommunication devices (telecommunication devices) are connected to the network 12 will be assumed. Each telecommunication device has a configuration and a function similar to those of the telecommunication device 11a described above. As illustrated in FIG. 5, one of the five telecommunication devices is a host terminal 11A (specifically, a terminal that is used by a teacher), and the other telecommunication devices are client terminals 11B to 11E (specifically, terminals used by students).

As illustrated in FIG. 5, video of two students is displayed on a display (display 22A) included in the host terminal 11A. It is assumed that the two students are users of the client terminal 11E. On the other hand, on the display 22B of the client terminal 11B, the display 22C of the client terminal 11C, the display 22D of the client terminal 11D, and the display 22E of the client terminal 11E, the video of the teacher who is the user of the host terminal 11A is displayed in a similar output form (in this example, a video image facing front). In this state, it is assumed that the teacher speaks to the students (students who are the users of the client terminal 11E) displayed on the display 22A, “Is it going well?”. Since the teacher is displayed to the student of each client terminal in the same manner, the student of each client terminal recognizes that the teacher speaks to each student, “Is it going well?”. As described above, there is a possibility that a discrepancy occurs between the recognition of the communication of the user of the host terminal 11A and the recognition of the communication of the user of each client terminal, and appropriate communication cannot be performed.

Therefore, in the present embodiment, arrangement information indicating a relationship between a plurality of information processing terminals, that is, between the host terminal and the client terminals is defined. Then, the bidirectional strength data based on the arrangement information is acquired, and control is performed to change the output form of the output unit that reproduces the video and voice on the basis of the bidirectional strength data. Such control may be performed by a host terminal or a client terminal, or may be performed by an information processing terminal (for example, a server) that does not directly participate in a remote lesson system, or the like. That is, the information processing device of the present disclosure may be a host terminal or a client terminal, or may be a server.

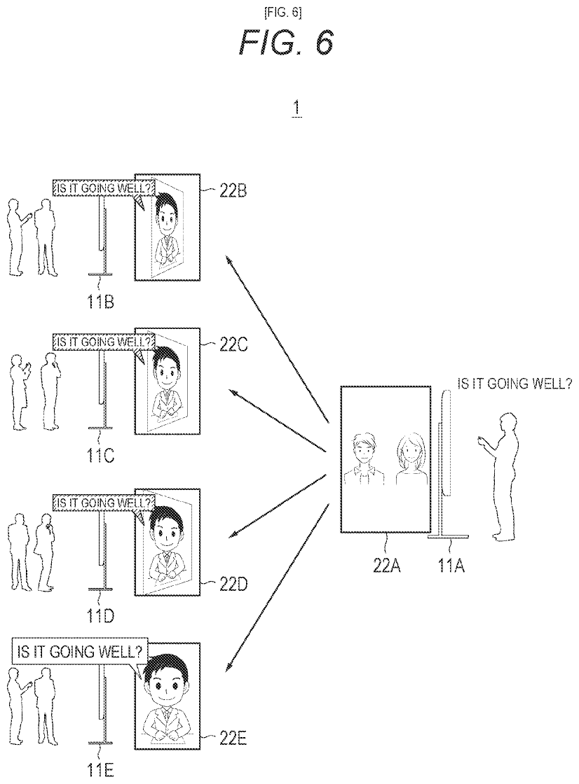

For example, as illustrated in FIG. 6, it is assumed that a communication target of the teacher who is the user of the host terminal 11A are the two students who are the users of the client terminal 11E. In this case, the video of the teacher is displayed on the display 22E in a concrete manner, in other words, in a form in which it can be recognized that the teacher intends to communicate with the users. For example, a teacher facing front is displayed on the display 22E.

On the other hand, the users of the other client terminals (the client terminals 11B to 11D) are not students with whom the teacher intends to communicate. Therefore, the video of the teacher is displayed on the displays 22B to 22D of the client terminals 11B to 11D in an abstract manner, in other words, in a form in which it can be recognized that the teacher does not intend to communicate with the users. For example, the teacher is displayed such that the teacher does not face front and the size of the teacher is small.

By performing the above-described processing, the students who are the users of the client terminal 11E can recognize that the teacher's utterance is for themselves. Furthermore, the students who are the users of the client terminals 11B to 11D can recognize that the utterance of the teacher is not for them. Therefore, only the students who are the users of the client terminal 11E can respond to the utterance of the teacher. Thus, the above-described problem does not occur, and smooth communication can be achieved.

### Information Used in the Present Embodiment

### Arrangement Information

Information used in the present embodiment for performing the processing described above will be described. First, the arrangement information will be described. The arrangement information is information indicating a relationship between information processing terminals, specifically, between a host terminal and a plurality of client terminals.

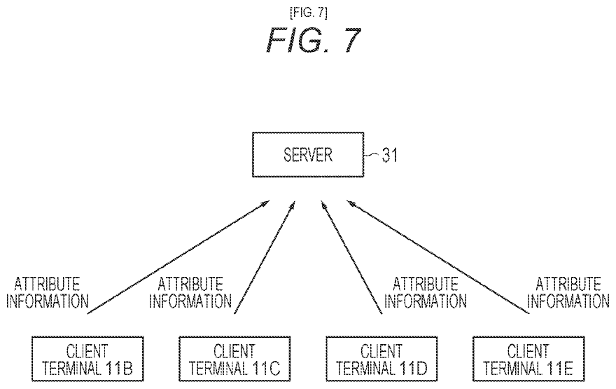

The arrangement information is generated, for example, on the basis of the attribute information. Furthermore, the arrangement information is generated, for example, by a server. For example, as illustrated in FIG. 7, each of the client terminals 11B to 11E transmits the attribute information of the user of the client terminal to a server 31 using the communication function. The server 31 generates the arrangement information by using the attribute information transmitted from each client terminal.

As an example, the position in a virtual classroom and the team number are transmitted from each client terminal to the server 31 as attribute information. Specifically, the attribute information “left row/team 1” is transmitted from the client terminal 11B to the server 31. Furthermore, the attribute information “left row/team 2” is transmitted from the client terminal 11C to the server 31. Furthermore, the attribute information “right row/team 3” is transmitted from the client terminal 11D to the server 31. Furthermore, the attribute information “right row/team 4” is transmitted from the client terminal 11E to the server 31.

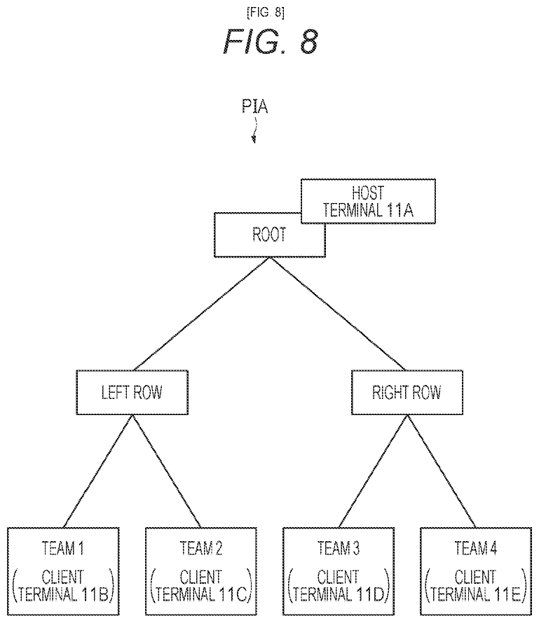

The server 31 generates the arrangement information on the basis of the attribute information transmitted from each client terminal. FIG. 8 illustrates an example of the arrangement information (arrangement information PIA) generated by the server 31. As illustrated in FIG. 8, the arrangement information PIA has, for example, a hierarchical structure (tree structure). That is, the arrangement information PIA has “root” as a starting point, and has “left row” and “right row” as a level below the root. Moreover, the arrangement information PIA has each team, in other words, the arrangement positions of the client terminals in the arrangement information PIA, as a level below “root”. Specifically, the arrangement information PIA includes “team 1 (corresponding to the attribute information of the client terminal 11B)” and “team 2 (corresponding to the attribute information of the client terminal 11C)” as a level below “left row”. Furthermore, the arrangement information PIA includes “team 3 (corresponding to the attribute information of the client terminal 11D)” and “team 4 (corresponding to the attribute information of the client terminal 11E)” as a level below “right row”. Note that the attribute in the arrangement information and the attribute corresponding to each client terminal (team name in this example) are also referred to as nodes as appropriate in the following description.

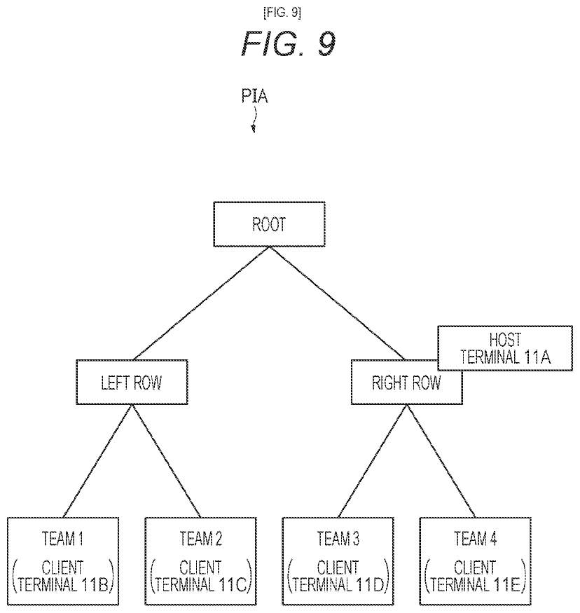

In the arrangement information, the host terminal 11A is arranged. For example, as illustrated in FIG. 8, the host terminal 11A (a terminal used by the teacher) is arranged at a position corresponding to the root in the arrangement information PIA by default. Note that the arrangement position of the host terminal 11A in the arrangement information PIA is not limited to the root. For example, the host terminal 11A may be arranged at a node specified in advance by the host terminal 11A. Specifically, as illustrated in FIG. 9, the host terminal 11A may be arranged at the node “right row”. Note that, in the present embodiment, the arrangement information PIA generated once can be changed. Furthermore, the arrangement position of the host terminal 11A in the arrangement information PIA is changed. For example, the arrangement position of the host terminal 11A is changed (moved) from the root to the node “right row” or to the node “left row”, or from the node “right row” to the node “left row”.

Note that, in the above-described example, the client terminals transmit the attribute information to the server, but the present invention is not limited to this example. For example, the arrangement information may be generated on the basis of the attribute information input by the host terminal. Specifically, the host terminal may instruct a node such as a team or a right row, which is an example of the attribute information, and a client terminal belonging to the node to the server, and the server may generate the arrangement information according to the instruction.

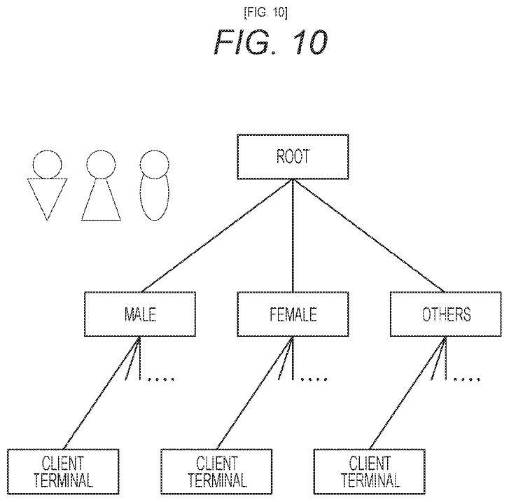

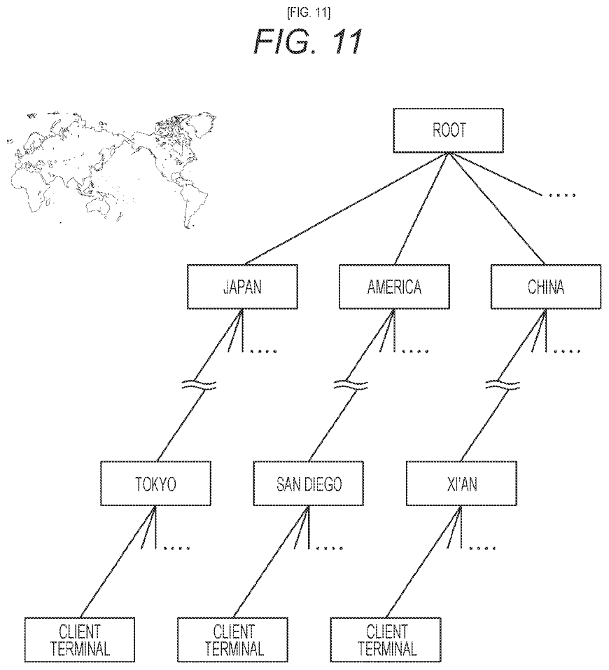

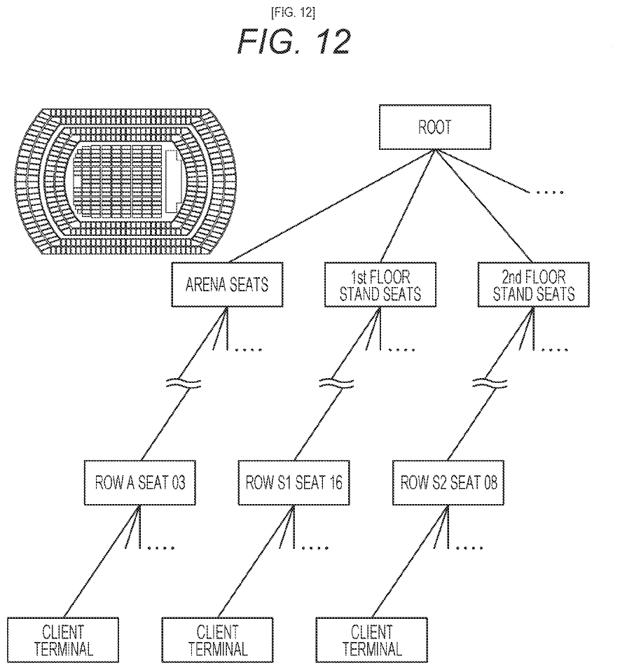

FIG. 10 illustrates another example of the arrangement information. In the example illustrated in FIG. 10, gender (male/female/other) is used as the attribute information, and arrangement information generated according to the gender is illustrated. FIG. 11 illustrates another example of the arrangement information. In the example illustrated in FIG. 11, the place of residence (country name/city) is used as the attribute information, and arrangement information generated according to the place of residence is illustrated. FIG. 12 illustrates another example of the arrangement information. In the example illustrated in FIG. 12, the seat position of a ticket for an event such as a live show or a movie is used as the attribute information, and arrangement information generated according to the seat position is illustrated. The seat position in the present example is, for example, a virtual seat position, and a screen of a movie or an artist of live show viewed from the virtual seat position is displayed on the display of the client terminal. Furthermore, in a case of the present example, for example, only by inputting a ticket identifier (ID) to the client terminal, the seat position associated with the ticket is transmitted to the server, and the server can generate the arrangement information illustrated in FIG. 12 on the basis of the seat position. That is, the input of the attribute information to the client terminal can be simplified.

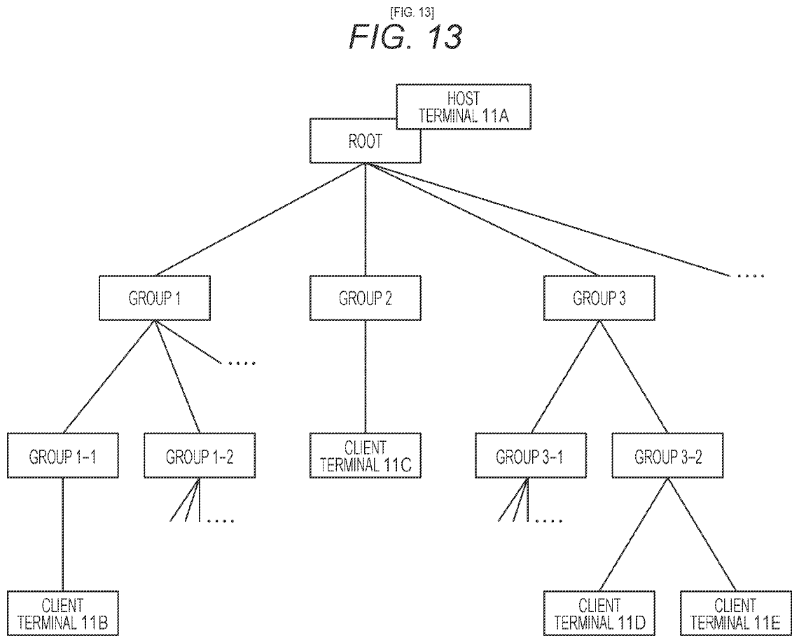

Note that the attribute information is not necessarily required for generating the arrangement information. In a case where there is no attribute information, for example, each client terminal is classified into any group having no attribute as illustrated in FIG. 13. The classification may be performed randomly, or may be performed according to a preset rule.

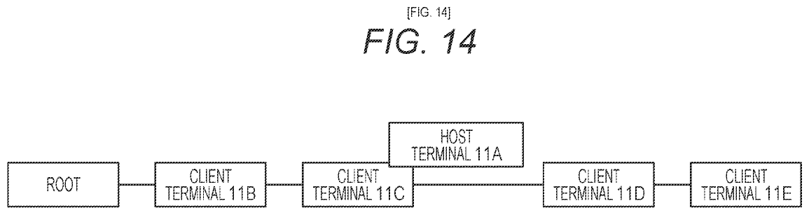

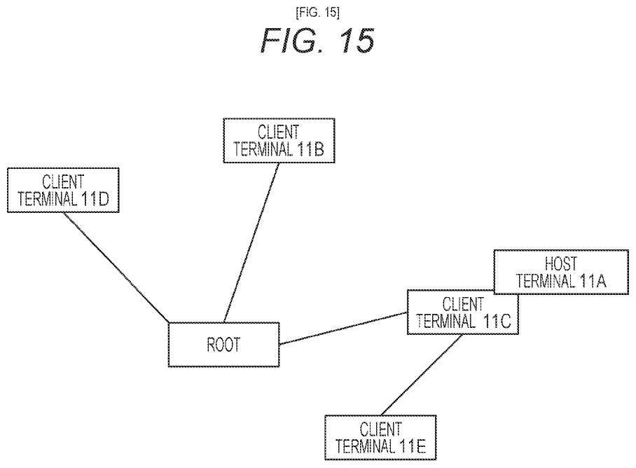

Furthermore, although the arrangement information having a tree structure has been described, the structure of the arrangement information may be a structure other than the tree structure. For example, as illustrated in FIG. 14, the arrangement information may have a linear list structure. Furthermore, the arrangement information may have a graph structure as illustrated in FIG. 15. Note that, in FIGS. 14 and 15, the host terminal 11A and the client terminal 11C are illustrated to overlap each other, which indicates that the arrangement position of the host terminal 11A and the arrangement position of the client terminal 11C are the same.

### [Bidirectional Strength Data]

### (Distance Data)

Next, the bidirectional strength data will be described. The bidirectional strength data is data corresponding to the bidirectional strength based on the arrangement information described above. The bidirectional strength data includes distance data indicating a distance to a predetermined information processing terminal in the above-described arrangement information. The bidirectional strength data in this example includes distance data indicating the distance between the host terminal and each of the client terminals described above.

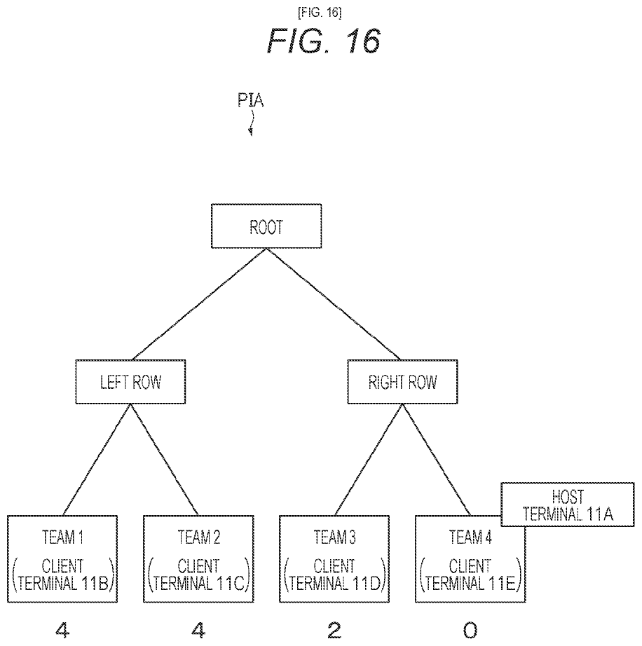

A specific example of the distance data will be described. FIG. 16 illustrates the above-described arrangement information PIA. In the arrangement information PIA, the arrangement position of the host terminal 11A is, for example, the same as the arrangement position of team 4 (client terminal 11E).

The distance data is defined by, for example, the number of movement steps to the arrangement position of the host terminal 11A through nodes in the arrangement information PIA. Since the arrangement position of the host terminal 11A and the arrangement position of the client terminal 11E are the same, the distance data indicating the distance from the client terminal 11E to the host terminal 11A is “0”. Furthermore, when the host terminal 11A is viewed from the client terminal 11D, the distance data is “2” since the number of movement steps to reach the arrangement position of the host terminal 11A through the node “right row” is 2. Furthermore, when the host terminal 11A is viewed from the client terminal 11C, the distance data is “4” since the number of movement steps to reach the arrangement position of the host terminal 11A through the node “left row”, root, and the node “right row” is 4. The distance data from the client terminal 11B to the host terminal 11A can be similarly defined.

In the present embodiment, control is performed to change the output form of the output unit according to the distance data that is one of the bidirectional strength data. As a result, the relationship between the host terminal 11A and each client terminal can be presented to the user of each terminal.

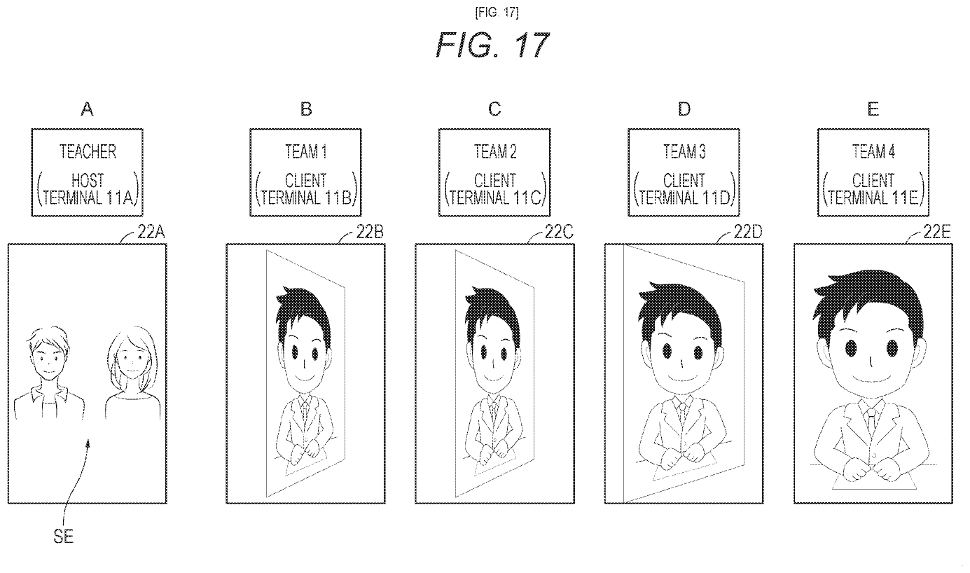

For example, the video display form of the display 22, which is one of the output units, is changed according to the distance data. FIG. 17A illustrates an example of video displayed on the display 22A of the teacher's terminal, that is, the host terminal 11A. All or some of the students who are the users of the client terminals 11B to 11E are displayed on the display 22A. Furthermore, FIGS. 17B to 17E illustrate examples of video displayed on the displays 22B to 22E of the client terminals 11B to 11E. On the displays 22B to 22E, the teacher is displayed. Note that, in the following description, a teacher who is the user of the host terminal 11A is referred to as a teacher TH, and students who are the users of the client terminals 11B to 11E are referred to as students SB to SE (here, even if each student is more than one, they are not distinguished) as appropriate.

As an example, the output form of the video is changed such that information corresponding to the host terminal 11A and the client terminals 11B to 11E (video of the teacher TH and the students SB to SE in this example) is expressed in a more abstract manner as the distance data is larger. Furthermore, the output form is changed such that information corresponding to the host terminal 11A and the client terminals 11B to 11E is expressed in a more concrete manner as the distance data is smaller.

As illustrated in FIG. 16, the distance data between the host terminal 11A and the client terminal 11E is “0”. That is, when viewed from the host terminal 11A, the distance data of the client terminal 11E is the smallest among the client terminals 11B to 11E. Therefore, the figure of the student SE who is the user of the client terminal 11E is displayed in a concrete manner on the display 22A of the host terminal 11A. For example, a figure of only the student SE is displayed on the display 22A (see FIG. 17A). On the other hand, when viewed from the client terminal 11E, the distance data to the host terminal 11A is also the smallest. Therefore, the figure of the teacher TH is displayed in a concrete manner on the display 22E of the client terminal 11E. For example, the display 22E displays the figure of the teacher TH in a large size in a state of facing front (see FIG. 17E).

The distance data between the host terminal 11A and the client terminal 11D is “2”. Therefore, on the display 22D of the client terminal 11D, the figure of the teacher TH is displayed in a slightly more abstract manner than the figure of the teacher TH displayed on the display 22E of the client terminal 11E. For example, the figure of the teacher TH is displayed to face slightly obliquely (not to face front) and slightly small on the display 22D (see FIG. 17D).

The distance data between the host terminal 11A and the client terminal 11C is “4”. Therefore, on the display 22C of the client terminal 11C, the figure of the teacher TH is displayed in a sill more abstract manner than the figures of the teacher TH displayed on the display 22E and the display 22D. For example, the figure of the teacher TH is displayed to face largely obliquely (not to face front) and small on the display 22C (see FIG. 17C). The distance data between the host terminal 11A and the client terminal 11B is also “4”. Therefore, the figure of the teacher TH is displayed on the display 22B of the client terminal 11B in a display form similar to that on the display 22C (see FIG. 17B).

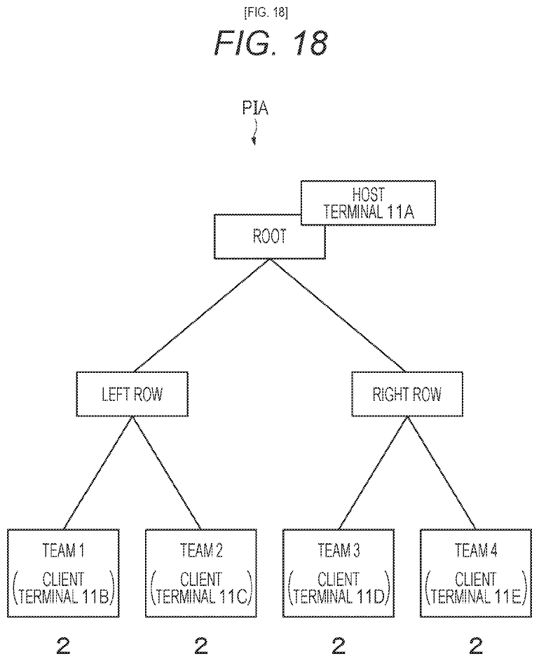

Meanwhile, as described above, in the present embodiment, the arrangement position of the host terminal 11A in the arrangement information PIA can be changed. For example, as illustrated in FIG. 18, an example in which the arrangement position of the host terminal 11A is changed from the position of the client terminal 11E to the root will be considered. The distance data between the host terminal 11A and each client terminal is changed resulting from the arrangement change of the host terminal 11A. Specifically, the distance data between the host terminal 11A and each client terminal is changed to “2” as illustrated in FIG. 18.

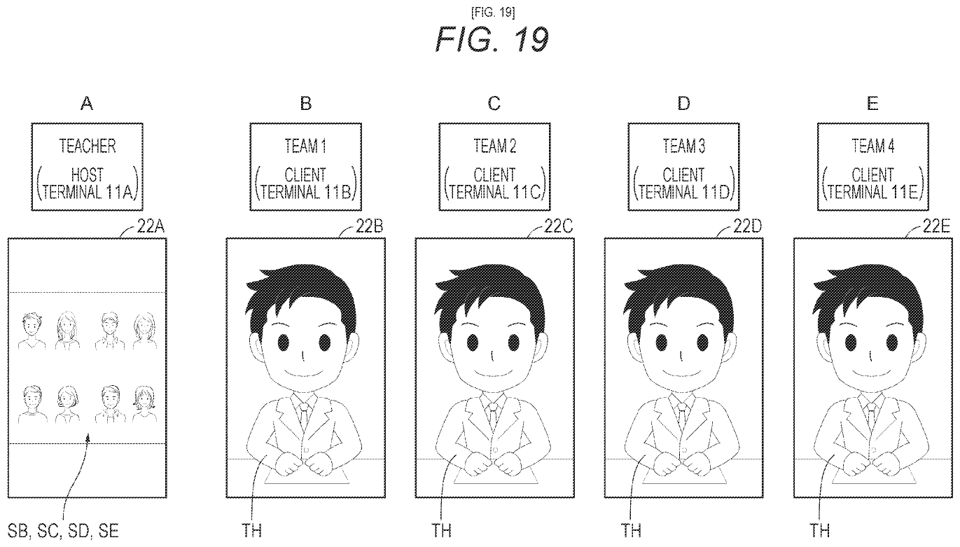

As the distance data is changed, the display form of the video is also changed as illustrated in FIGS. 19A to 19E. For example, the distance data from the host terminal 11A to the client terminals are now the same and “2”. Therefore, video of all the students (the students SB to SE) viewed from above is displayed on the display 22A of the host terminal 11A (see FIG. 19A). At this time, in consideration of the attribute information, the students of the client terminal 11B and the client terminal 11C (student SB and SC) may be displayed on the left side when facing the display 22A, and the students of the client terminal 11D and the client terminal 11E (student SD and SE) may be displayed on the right side when facing the display 22A.

On the other hand, the distance data from each client terminal to the host terminal 11A is also “2”. Therefore, the teacher TH is displayed on the display (displays 22B to 22E) of each client terminal in a similar display form (see FIGS. 19B to 19E).

### (Interaction Target Scope)

The bidirectional strength data may include interaction target scope data. The interaction target scope data is data indicating whether or not a client terminal is included in a range (hereinafter, also referred to as an interaction target scope as appropriate) in which the interaction via the output unit is possible. The interaction target scope is set on the basis of the above-described distance data, for example. For example, a threshold is set for the distance data with respect to the host terminal 11A, and the interaction target scope is set so as to include a client terminal corresponding to the distance data equal to or less than the threshold.

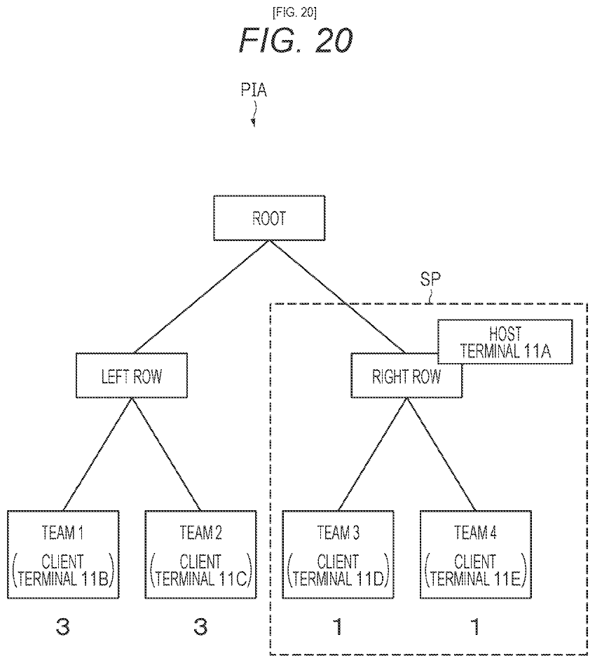

For example, an example in which the interaction target scope is set to include a client terminal having distance data equal to or less than “1” is considered. As illustrated in FIG. 20, it is assumed that the arrangement position of the host terminal 11A is at the node “right row”. In this case, the distance data from the host terminal 11A to the client terminals 11B to 11E is “3”, “3”, “1”, and “1”, respectively. Therefore, in the present example, the client terminals 11D and 11E are client terminals included in an interaction target scope (an interaction target scope SP indicated by the dotted line in FIG. 20). On the other hand, the client terminals 11B and 11C are client terminals not included in the interaction target scope SP.

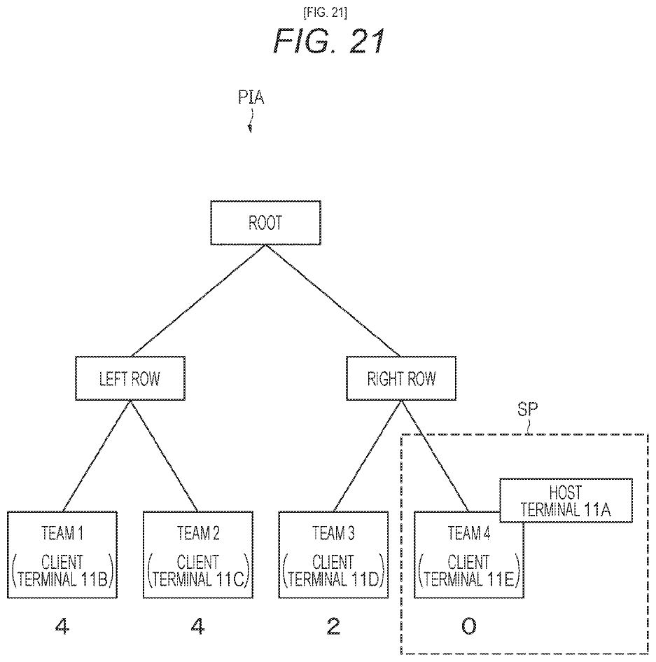

Resulting from the change of the arrangement position of the host terminal 11A, a client terminal included in the interaction target scope SP can also be changed. For example, it is assumed that the host terminal 11A moves to the position of the client terminal 11E as illustrated in FIG. 21. As the host terminal 11A moves, the distance data between the host terminal 11A and the client terminal 11E changes from “1” to “0” as illustrated in FIG. 21. Furthermore, the distance data between the host terminal 11A and the client terminal 11E changes from “1” to “2”. Therefore, the client terminal included in the interaction target scope SP is only the client terminal 11E, and the other client terminals 11B to 11D are client terminals not included in the interaction target scope SP.

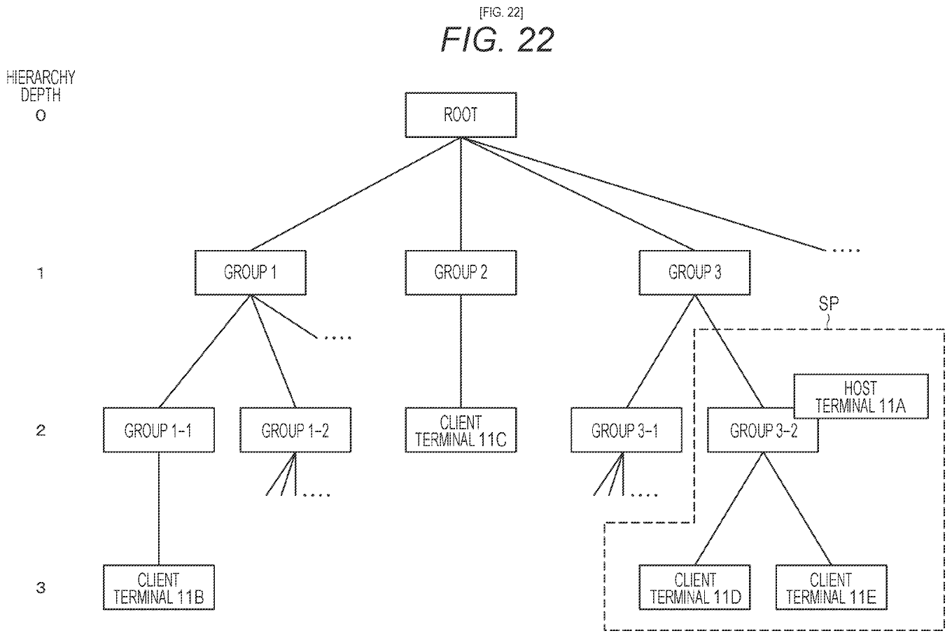

Note that the interaction target scope is not necessarily based on the distance data. For example, as illustrated in FIG. 22, the interaction target scope SP may be set to include all the client terminals arranged in levels lower than the host terminal 11A in the arrangement information.

For example, in a case where a predetermined client terminal is not included in the interaction target scope, control is performed to change the output form of the output unit so that information corresponding to the client terminal is expressed in an abstract manner. Furthermore, in a case where a predetermined client terminal is included in the interaction target scope, control is performed to change the output form of the output unit so that information corresponding to the client terminal is expressed in a concrete manner.

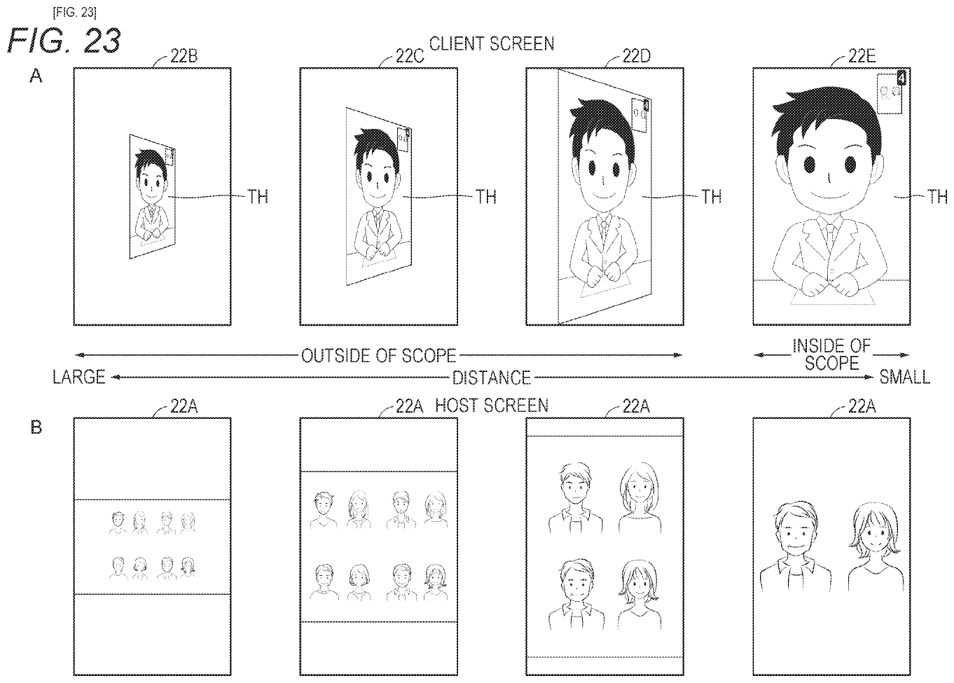

FIG. 23 illustrates a display example of information (for example, the teacher TH) corresponding to the host terminal displayed on the displays of the client terminals. The rightmost diagram among the four diagrams of FIG. 23A illustrates the display 22E of a client terminal included in the interaction target scope SP (for example, the client terminal 11E). The display 22E displays the teacher TH as if he/she faces front. Note that, as illustrated in the figure, information regarding the current interaction partner of the teacher TH, that is, the client terminal in the interaction target scope SP (for example, a team name) may be displayed.

The figure of the teacher TH is displayed in an abstract manner on the displays 22B to 22D of the client terminals (in this example, the client terminals 11B to 11D) not included in the interaction target scope. For example, the figure of the teacher TH is displayed to face obliquely such that the teacher TH does not face front. At this time, the figure is displayed also according to the distance data. That is, the figure of the teacher TH is displayed in a smaller size as the distance data is larger. As illustrated in FIG. 23B, similar display control is performed also for the display 22A of the host terminal 11A. As described above, in the present embodiment, the output form of the output unit is changed on the basis of the distance data included in the bidirectional strength data and the interaction target scope data indicating whether or not the corresponding client terminal is inside the interaction target scope.

Although the display forms are schematically illustrated in FIGS. 23A and 23B, for example, an evaluation value corresponding to the bidirectional strength data may be obtained by performing predetermined calculation using the distance data and the interaction target scope data. The calculation is a calculation resulting in an evaluation value that is higher as the distance data is smaller and as the client terminal is within the interaction target scope data. By such calculation, an evaluation value corresponding to the bidirectional strength data is obtained. When the evaluation value is higher, the video of the teacher and the video of the student are displayed in a more concrete manner, and when the evaluation value is lower, the video of the teacher and the video of the student are displayed in a more concrete manner.

### Specific Example of Output Form

Next, a specific example of the output form based on the bidirectional strength data will be described. Note that each figure used in the following description illustrates an output form in a concrete manner due to a large bidirectional strength (strong relevance) on the rightmost, and the bidirectional strength becomes smaller toward the left side (weak relevance), resulting in an output form in a more abstract manner.

### (Display Example on Client Terminal Side)

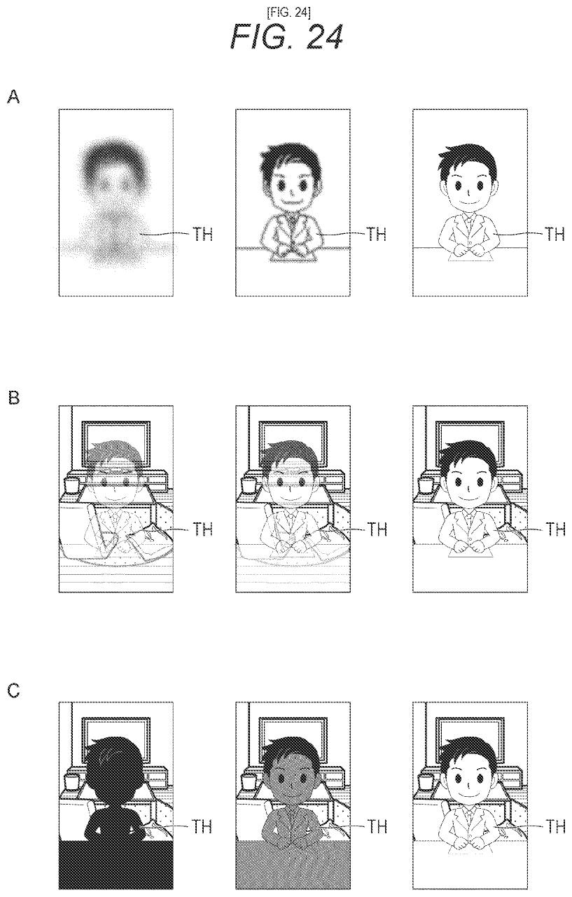

First, a change example of the output form based on the bidirectional strength data, specifically, a change example of the display form on the client terminal side will be described. The following display form can be realized by known image processing. The example illustrated in FIG. 24A is an example in which the figure of the teacher TH is displayed more clearly as the bidirectional strength is higher, and the figure of the teacher TH is more blurred as the bidirectional strength is lower. The example illustrated in FIG. 24B is an example in which the figure of the teacher TH is displayed more clearly as the bidirectional strength is higher, and the figure of the teacher TH is displayed lighter in terms of density as the bidirectional strength is lower. This example can be realized by changing the value in image processing called a blending. The example illustrated in FIG. 24C is an example in which the figure of the teacher TH is displayed more clearly as the bidirectional strength is higher, and the figure of the teacher TH is displayed is darker toward black (recognition of the figure as the teacher TH is more difficult) as the bidirectional strength is lower.

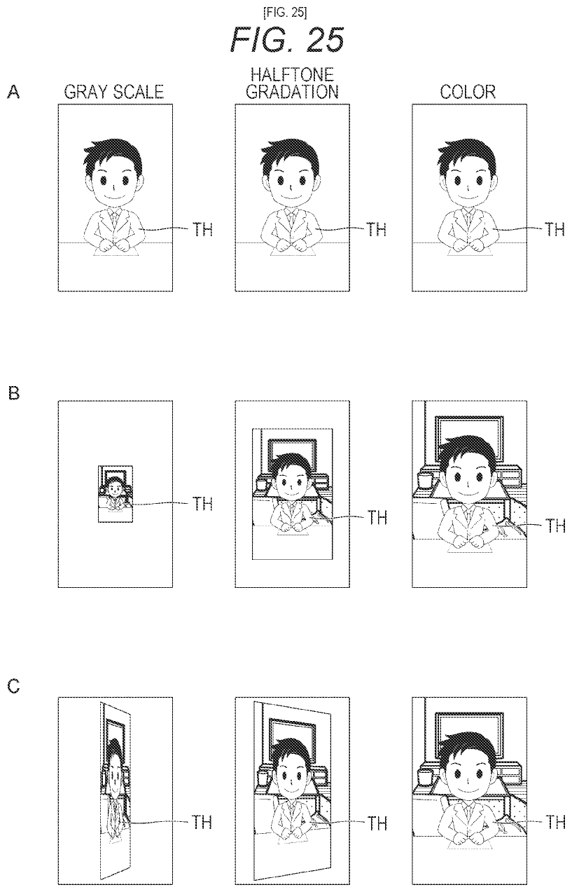

The example illustrated in FIG. 25A is an example in which the figure of the teacher TH is displayed in color as the bidirectional strength is higher, and the level of gradation in video of the figure of the teacher TH is lower as the bidirectional strength is lower. In a case where the bidirectional strength is the lowest, the figure of the teacher TH is displayed in gray scale. The example illustrated in FIG. 25B is an example in which the figure of the teacher TH is displayed larger as the bidirectional strength is higher, and the figure of the teacher TH is displayed smaller as the bidirectional strength is lower. The example illustrated in FIG. 25C is an example in which the figure of the teacher TH is displayed to face front as the bidirectional strength is higher, and the figure of the teacher TH is displayed to face sideways as the bidirectional strength is lower.

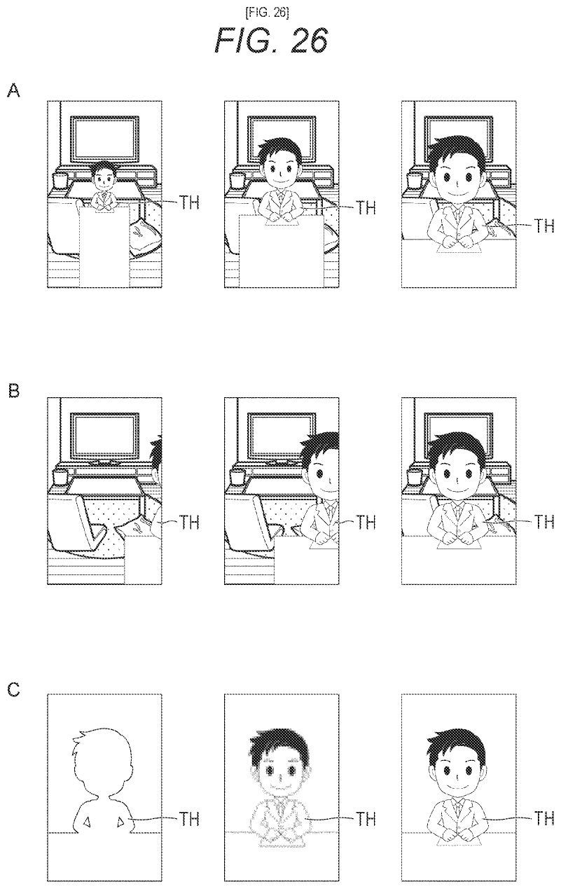

The example illustrated in FIG. 26A is an example in which the figure of the teacher TH is displayed closer as the bidirectional strength is higher, and the figure of the teacher TH is displayed farther as the bidirectional strength is lower. The example illustrated in FIG. 26B is an example in which the area of the figure of the displayed teacher TH is larger as the bidirectional strength is higher. In this example, the entire figure of the teacher TH is displayed in a case where the bidirectional strength is the highest, and a little part of the figure of the teacher TH is displayed in a case where the bidirectional strength is the lowest. The example illustrated in FIG. 26C is an example in which the figure of the teacher TH is displayed more clearly as the bidirectional strength is higher, and the figure of the teacher TH is blurred or only a part of the figure of the teacher TH is displayed as the bidirectional strength is lower.

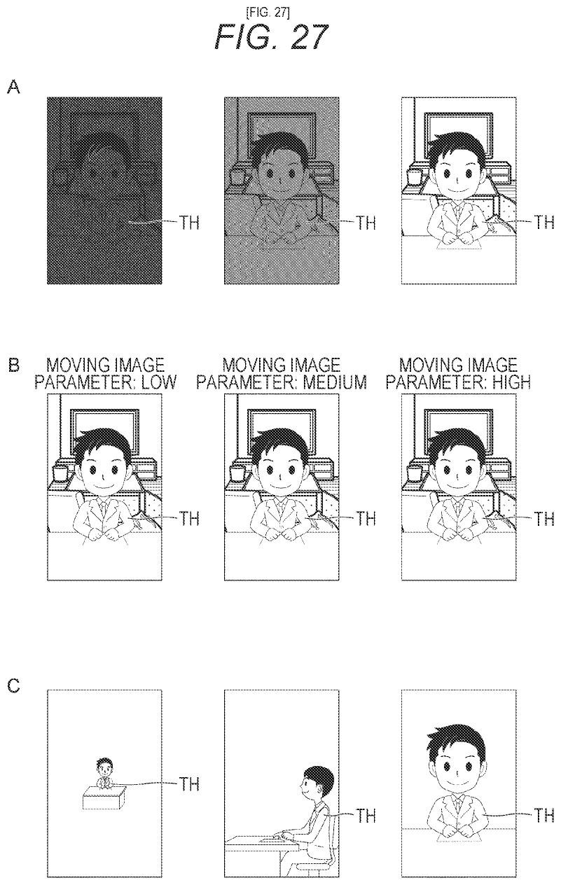

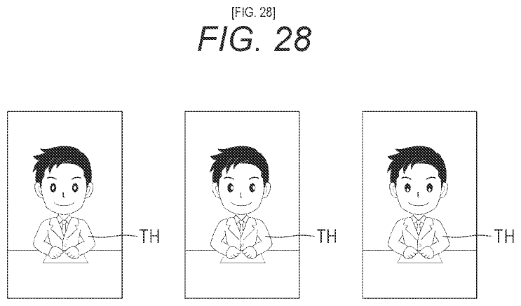

The example illustrated in FIG. 27A is an example in which the luminance of video including the teacher TH is higher as the bidirectional strength is higher, and the luminance of video including the teacher TH is lower as the bidirectional strength is lower. The example illustrated in FIG. 27B is an example in which the moving image parameter is changed such that the figure of the teacher TH is displayed more clearly as the bidirectional strength is higher, and it is more difficult to recognize the video of the figure of the teacher TH as the bidirectional strength is lower. Examples of the moving image parameter include a frame rate, a resolution, a bit rate, and the like. For example, at least one of the frame rate, the resolution, and the bit rate is increased as the bidirectional strength is higher, and for example, at least one of the frame rate, the resolution, and the bit rate is decreased as the bidirectional strength is lower. The example illustrated in FIG. 27C is an example in which cameras that images the figure of the teacher TH are switched such that the entire figure of the teacher TH is imaged as the bidirectional strength is higher. FIG. 28 illustrates an example in which the line-of-sight of the teacher TH is switched according to the bidirectional strength.

### (Example of Sound Processing on Client Terminal Side)

Next, a change example of the output form based on the bidirectional strength data, specifically, a change example of the sound reproduction form on the client terminal side will be described. The sound (for example, the voice of teacher TH) is reproduced in a more concrete manner (clearly) as the bidirectional strength is higher, and the sound (for example, the voice of teacher TH) is reproduced in a more abstract manner (unclearly) as the bidirectional strength is lower. Note that in each figure referred in the following description, the volume of the sound and the like may be schematically illustrated using notes. Furthermore, the output form described below can be realized by known sound data processing.

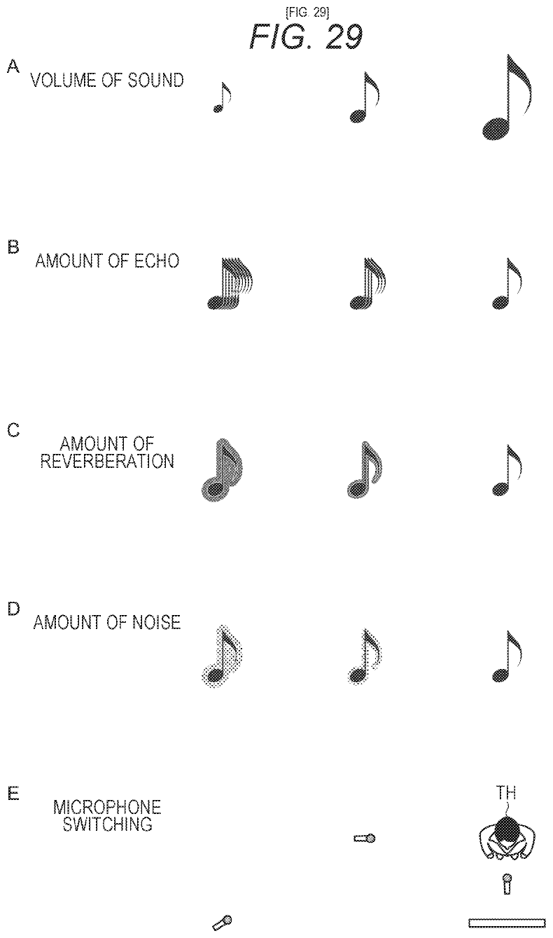

The example illustrated in FIG. 29A is an example in which the volume of the reproduced sound is larger as the bidirectional strength is higher, and the volume of the reproduced sound is smaller as the bidirectional strength is lower. The example illustrated in FIG. 29B is an example in which the amount of echo added to the reproduced sound is smaller as the bidirectional strength is higher, and the amount of echo added to the reproduced sound is larger as the bidirectional strength is lower. The example illustrated in FIG. 29C is an example in which the reverberation added to the reproduced sound is smaller as the bidirectional strength is higher, and the reverberation added to the reproduced sound is larger as the bidirectional strength is lower. The example illustrated in FIG. 29D is an example in which the noise added to the reproduced sound is smaller as the bidirectional strength is higher, and the noise added to the reproduced sound is larger as the bidirectional strength is lower. The example illustrated in FIG. 29E is an example in which the sound collected by a microphone closer to the teacher TH is reproduced as the bidirectional strength is higher, and the sound collected by a microphone farther from the teacher TH is reproduced as the bidirectional strength is lower.

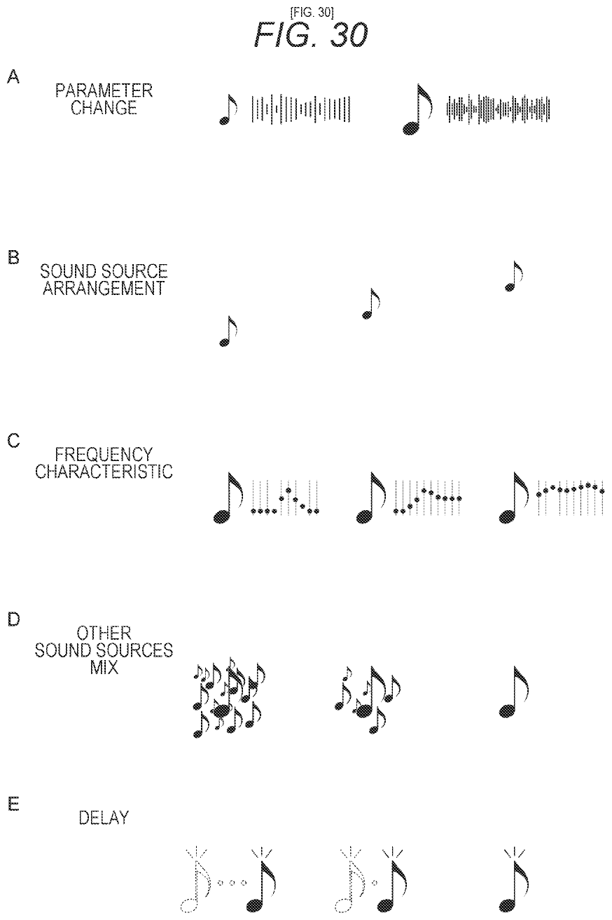

FIG. 30A illustrates an example in which parameters in the sound reproduction processing are changed such that the sound is reproduced in a more concrete manner (clearly) as the bidirectional strength is higher, and the sound is reproduced in a more abstract manner (unclearly) as the bidirectional strength is lower. Examples of the parameter include a sampling frequency, a bit rate, and the like. FIG. 30B illustrates an example in which the arrangement of the sound source is changed according to the bidirectional strength. For example, the sound is reproduced so as to be localized closer to the front of the user of the client terminal as the bidirectional strength is higher, and the sound is reproduced so as to be localized at a position farther from the user of the client terminal as the bidirectional strength is lower. FIG. 30C illustrates an example in which the frequency characteristic is changed according to the bidirectional strength. FIG. 30D illustrates an example in which only the voice of the teacher TH is reproduced as the bidirectional strength is higher, and the voice of other sound sources is mixed with the voice of the teacher TH so that the voice of the teacher is hardly heard as the bidirectional strength is lower. FIG. 30E illustrates an example in which the delay of the reproduced sound is smaller as the bidirectional strength is higher, and the delay of the reproduction sound is larger as the bidirectional strength is lower.

### (Display Example on Host Terminal Side)

Next, a change example of the output form based on the bidirectional strength data, specifically, a change example of the display form on the host terminal side will be described. For example, the host terminal 11A can output video or sound corresponding to any client terminal to the output unit of the display 22A or the like included in the host terminal.

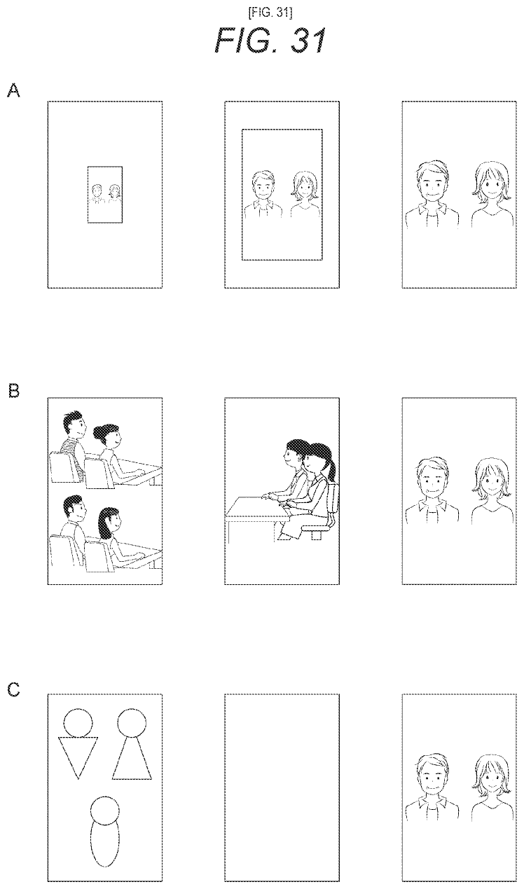

FIG. 31A is an example in which the information (for example, a video image of a student) corresponding to the client terminal is displayed in a larger size as the bidirectional strength with the client terminal is higher. FIG. 31B illustrates an example in which the camera is switched such that the information corresponding to the client terminal is displayed in a more concrete manner as the bidirectional strength is higher. In a case where the bidirectional strength with the client terminal is high, the video captured by a camera arranged in front of the student using the client terminal is displayed, and in a case where the bidirectional strength with the client terminal is low, the video captured by a camera arranged beside or behind the student using the client terminal is displayed. FIG. 31C is an example in which as the bidirectional strength with a client terminal is higher, the video of the student corresponding to the client terminal is displayed and as the bidirectional strength with a client terminal is lower, the video of the student corresponding to the client terminal is schematically displayed with an emoticon or the like.

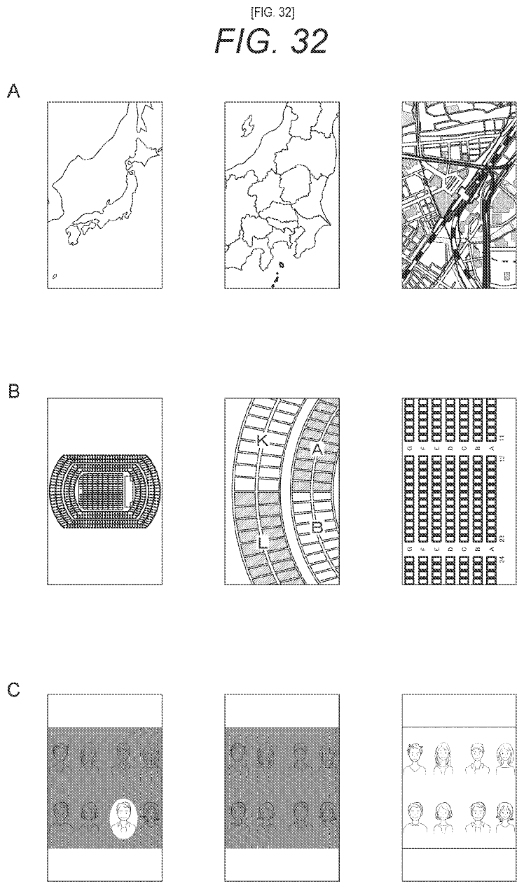

FIG. 32A is an example in which a more concrete attribute is displayed as the bidirectional strength with the client terminal is higher. For example, a concrete map (detailed map) is displayed in a case where the bidirectional strength is high, and a rough map illustrating, for example, regions or countries is displayed as the bidirectional strength is lower. FIG. 32B illustrates an example in which an attribute (for example, the seat position) of the client terminal is displayed as it is. FIG. 32C illustrates an example in which the user of the client terminal specified by the host terminal 11A is displayed in a manner spotlighted.

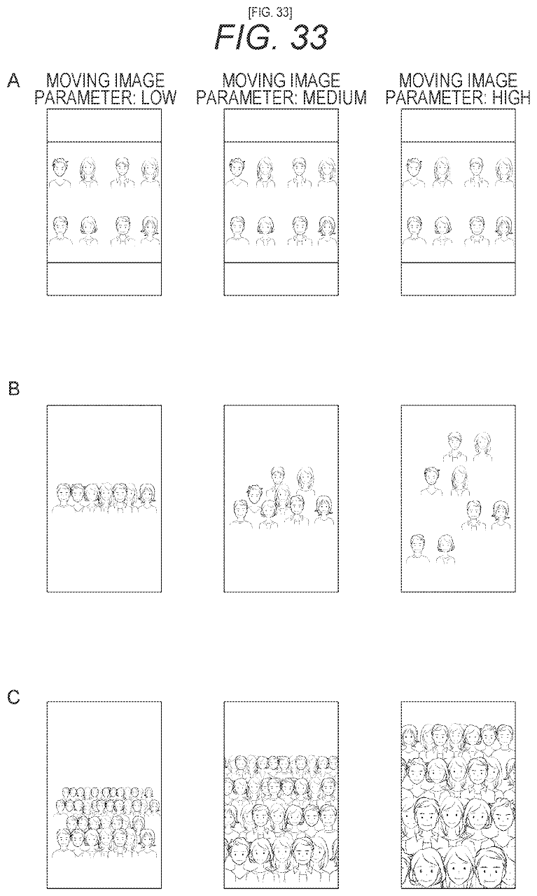

The example illustrated in FIG. 33A is an example in which the moving image parameter is changed such that the figure of the student is displayed more clearly as the bidirectional strength is higher, and it is more difficult to recognize the video of the figure of the student as the bidirectional strength is lower. Examples of the moving image parameter include a frame rate, a resolution, a bit rate, and the like. For example, at least one of the frame rate, the resolution, and the bit rate is increased as the bidirectional strength is higher, and for example, at least one of the frame rate, the resolution, and the bit rate is decreased as the bidirectional strength is lower. The example illustrated in FIG. 33B is an example in which the arrangement of students who are users of the client terminals is changed. The example illustrated in FIG. 33C is an example in which the position of the virtual viewpoint in the virtual space is changed according to the bidirectional strength.

[Response Request from Client Terminal]

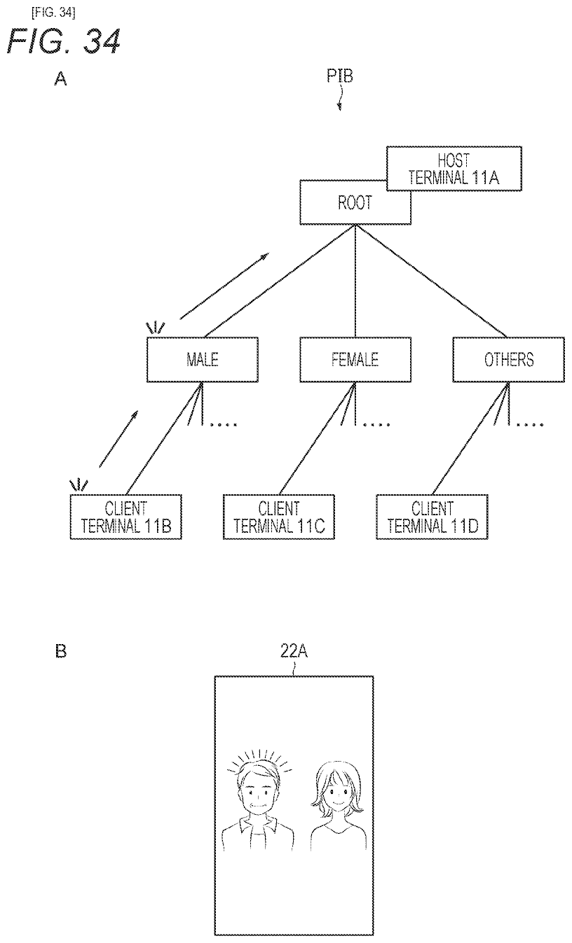

Next, processing related to a response request from the client terminal to the host terminal 11A will be described. For example, it is assumed that arrangement information PIB as illustrated in FIG. 34A is generated. It is assumed that an arrangement position of the host terminal 11A is a node. Furthermore, it is assumed that the arrangement position of the client terminal 11B is one level below the node “male”, the arrangement position of the client terminal 11C is one level below the node “female”, and the arrangement position of the client terminal 11D is one level below the node “others”. (Here, the client terminal 11E is omitted.)

It is assumed that a response request is made from the client terminal 11B to the host terminal 11A. The response request is transmitted to the host terminal 11A on the basis of the of the connection between the nodes of the arrangement information. Specifically, a response request is transmitted from the client terminal 11B to the host terminal 11A located at the root via the node “male”.

The host terminal 11A receives the response request from the client terminal 11B. As the response request is transmitted on the basis of the arrangement information, the host terminal 11A can recognize that the response request is made from the client terminal having the attribute “male”. Therefore, for example, as illustrated in FIG. 34B, video in which a male portion blinks is displayed on the display 22A of the host terminal 11A.

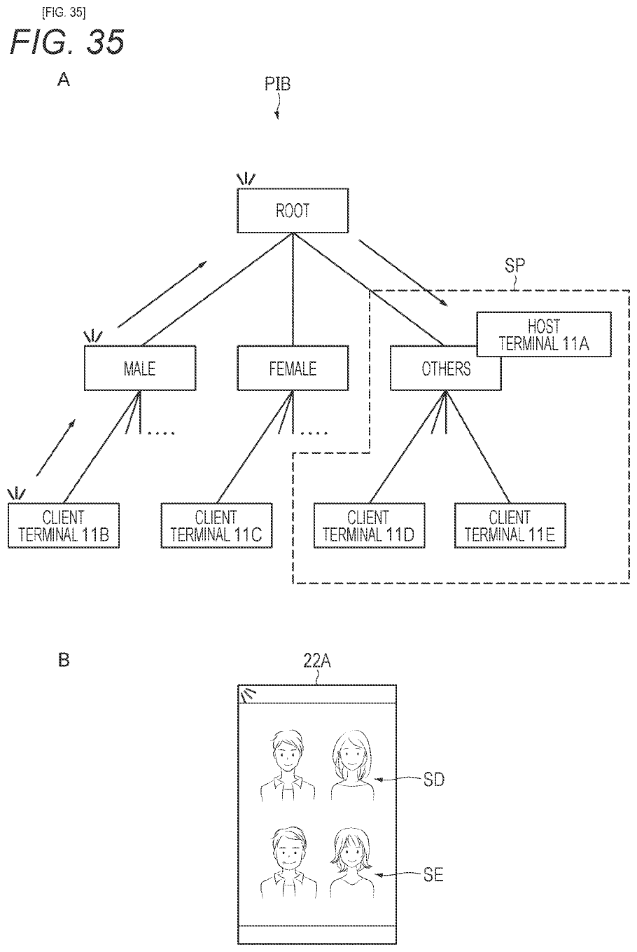

Note that, as illustrated in FIG. 35A, an example will be considered in which the arrangement position of the host terminal 11A is the node “others”, and the interaction target scope SP is set to a client terminal at an arrangement position that is one level below the node (in this example, the client terminals 11D and 11E). As illustrated in FIG. 35B, the users corresponding to the client terminals in the interaction target scope SP (students SD and SE) are displayed on the display 22A of the host terminal 11A.

Here, it is assumed that a response request is made from the client terminal 11B to the host terminal 11A. As illustrated in FIG. 35A, the response request is transmitted to the host terminal 11A positioned at the node “others” via the nodes “male” and “root”. Here, the response request made by the client terminal 11B is a response request from the outside the interaction target scope SP. In this case, an indication of the fact that there has been a response request is displayed in a manner that it is easy to recognize that the response request is from the outside of the interaction target scope SP. For example, as illustrated in FIG. 35B, the user of the host terminal 11A is notified that there has been a response request from the outside the interaction target scope SP by blinking the vicinity of the corner of the display 22A.

### [Configuration Example and Flow of Processing of Device]

### (Configuration Example of Host Terminal)

A configuration of a device that realizes the above-described processing and a flow of the processing will be described. First, a configuration example of a host terminal 100 (for example, corresponding to the above-described host terminal 11A) according to the present embodiment will be described.

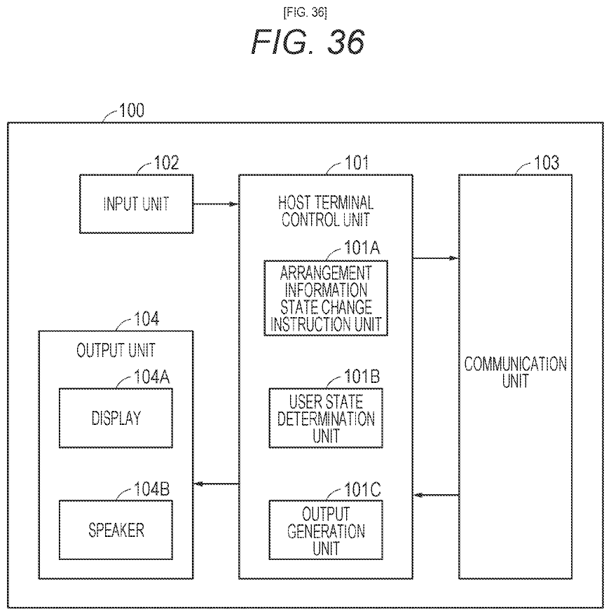

FIG. 36 is a block diagram illustrating a configuration example of the host terminal 100. The host terminal 100 includes, for example, a host terminal control unit 101, an input unit 102, a communication unit 103, and an output unit 104.

The host terminal control unit 101 controls the operation of the host terminal 100 as a whole. The host terminal control unit 101 includes, for example, a central processing unit (CPU), and includes a read only memory (ROM) in which a program is stored and a random access memory (RAM) used as a work memory or the like (note that illustration of these memories is omitted). The host terminal control unit 101 performs control to change the output form of the output unit 104 according to the bidirectional strength data based on the arrangement information indicating the relationship between the plurality of client terminals 200 including the host terminal 100 itself.

Specifically, the host terminal control unit 101 includes an arrangement information state change instruction unit 101A, a user state determination unit 101B, and an output generation unit 101C. The arrangement information state change instruction unit 101A generates arrangement information state change instruction data for changing the arrangement information. Note that the arrangement information state change instruction data may include data instructing change of the arrangement position of the host terminal (hereinafter, appropriately referred to as host terminal movement request data) in the arrangement information, may include data instructing change (reset) of the arrangement information itself (hereinafter, referred to as arrangement information change instruction data appropriately), or may include both of them. The user state determination unit 101B interprets the intention of the user on the basis of the input result to the input unit 102. The output generation unit 101C changes the output form of information in the output unit 104 on the basis of the bidirectional strength data. The way of changing the output form on the basis of the bidirectional strength data is determined, for example, by referring to a table in which the bidirectional strength data and the output form (example described using FIGS. 31A to 31C and the like) are associated with each other. The bidirectional strength data may include data indicating how to change the output form.

The input unit 102 includes a device that receives an operation input of a user, a sensor that senses the state of the user, and the like. Examples of the device that receives the operation input of the user include a keyboard, a touch panel, and the like. Examples of the sensor include a microphone that receives a voice input and a camera that receives a gesture input.

The communication unit 103 communicates with other information processing terminals, specifically, the client terminals 200 and a server 300 to be described later. The communication unit 103 includes a modem circuit according to a communication method, or the like (not illustrated).

The output unit 104 is a device that outputs information from another information processing terminal (for example, person video of a student or a live show audience). The output unit 104 according to the present embodiment includes a display 104A (corresponding to, for example, the display 22A described above) and a speaker 104B (corresponding to, for example, the speakers 27-1 and 27-2 described above).

### (Configuration Example of Client Terminal)

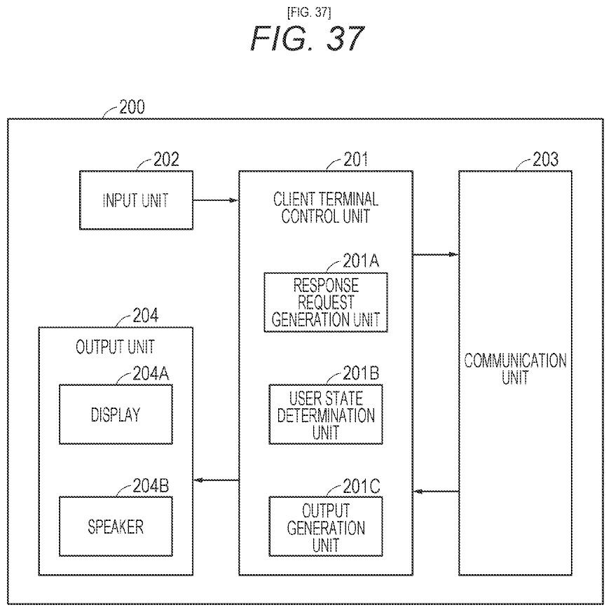

Next, a configuration example of the client terminals 200 (corresponding to, for example, the client terminals 11B to 11E described above) according to the present embodiment will be described. FIG. 37 is a block diagram illustrating a configuration example of each of the client terminals 200. The client terminal 200 includes, for example, a client terminal control unit 201, an input unit 202, a communication unit 203, and an output unit 204.

The client terminal control unit 201 controls the operation of the client terminal 200 as a whole. The client terminal control unit 201 includes, for example, a CPU, and includes a ROM in which a program is stored and a RAM used as a work memory or the like (note that illustration of these memories is omitted). The client terminal control unit 201 performs control to change the output form of the output unit 204 according to the bidirectional strength data based on the arrangement information indicating the relationship between the host terminal 100 and the plurality of client terminals 200 including the client terminal 200 itself.

Specifically, the client terminal control unit 201 includes a response request generation unit 201A, a user state determination unit 201B, and an output generation unit 201C. The response request generation unit 201A generates response request data for making a response request to the host terminal 100. The user state determination unit 201B interprets the intention of the user on the basis of the input result to the input unit 202. The output generation unit 201C changes the output form of information in the output unit 204 on the basis of the bidirectional strength data. The way of changing the output form on the basis of the bidirectional strength data is determined, for example, by referring to a table in which the bidirectional strength data and the output form (example described using FIGS. 24A to 24C and the like) are associated with each other. The bidirectional strength data may include data indicating how to change the output form.

The input unit 202 includes a device that receives an operation input of a user, a sensor that senses the state of the user, and the like. Examples of the device that receives the operation input of the user include a keyboard, a touch panel, and the like. Examples of the sensor include a microphone that receives a voice input and a camera that receives a gesture input.

The communication unit 203 communicates with other information processing terminals, specifically, the host terminal 100 and the server 300. The communication unit 203 includes a modem circuit according to a communication method, or the like (not illustrated).

The output unit 204 is a device that outputs information (for example, person video of a student or a live show audience) from another information processing terminal. The output unit 204 according to the present embodiment includes a display 204A and a speaker 204B.

### (Configuration Example of Server)

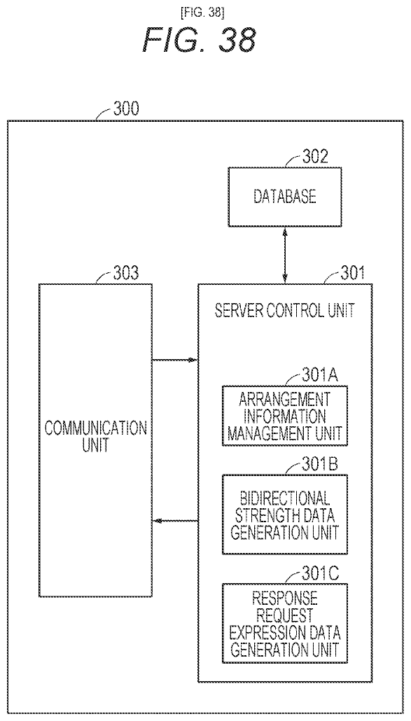

Next, a configuration example of the server 300 (for example, corresponding to the server 31 described above) according to the present embodiment will be described. FIG. 38 is a block diagram illustrating a configuration example of the server 300. The server 300 includes, for example, a server control unit 301, a database 302, and a communication unit 303.

The server control unit 301 controls the operation of the server 300 as a whole. The server control unit 301 includes, for example, a CPU, and includes a ROM in which a program is stored and a RAM used as a work memory or the like (note that illustration of these memories is omitted.).

The server control unit 301 includes an arrangement information management unit 301A, a bidirectional strength data generation unit 301B, and a response request expression data generation unit 301C. The arrangement information management unit 301A manages the arrangement information, specifically, generates or changes the arrangement information, and manages the arrangement position of the host terminal 100, and the like in the arrangement information. The bidirectional strength data generation unit 301B acquires the distance data in the arrangement information and the interaction target scope data, and generates the bidirectional strength data based on the distance data and the interaction target scope data. The response request expression data generation unit 301C generates response request expression data defining how to output a response request from the client terminals 200 to the host terminal 100.

The database 302 is a database that stores a processing result of the arrangement information management unit 301A, an attribute of each client terminal 200, and the like.

The communication unit 303 communicates with the host terminal 100 and the client terminals 200. The communication unit 303 includes a modem circuit according to a communication method, or the like.

### (Processing of Generating Arrangement Information)

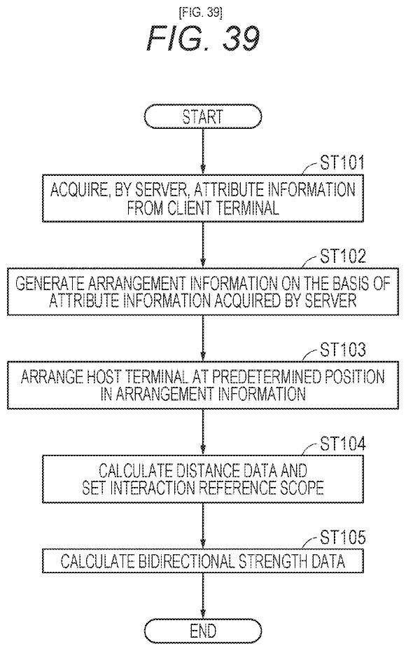

Next, a specific example of processing performed in a system in which the host terminal 100, the client terminals 200, and the server 300 described above are connected via a network will be described. First, a flow of processing of generating arrangement information will be described with reference to a flowchart illustrated in FIG. 39.

In step ST101, each of the plurality of client terminals 200 transmits the attribute information to the server 300 via the communication unit 203. The server 300 acquires the attribute information by receiving the attribute information transmitted from each client terminal 200 via the communication unit 303. The attribute information received by the communication unit 303 is supplied to the server control unit 301. Then, the processing proceeds to step ST102.

In step ST102, the arrangement information management unit 301A of the server control unit 301 generates the arrangement information using the attribute information. Then, the processing proceeds to step ST103.

In step ST103, the arrangement information management unit 301A determines the arrangement position of the host terminal 100 in the generated arrangement information. For example, the arrangement information management unit 301A arranges the host terminal 100 at the root in the generated arrangement information. The host terminal 100 may be arranged at a position other than the root, such as an arrangement position specified by the host terminal 100. Then, the processing proceeds to step ST104.

In step ST104, the arrangement information management unit 301A calculates distance data between the host terminal 100 and each client terminal 200 on the basis of the generated arrangement information. Furthermore, the arrangement information management unit 301A sets the interaction target scope on the basis of the generated arrangement information. The criterion regarding the setting of the interaction target scope may be determined in advance or may be instructed by the host terminal 100. Then, the processing proceeds to step ST105.

In step ST105, the bidirectional strength data generation unit 301B generates the bidirectional strength data for each client and the bidirectional strength data for each client terminal 200 viewed from the host terminal 100 on the basis of the distance data and the interaction target scope data indicating whether or not the corresponding client terminal is inside the interaction target scope. The bidirectional strength data is transmitted to the host terminal 100 and the client terminals 200. Note that, although not illustrated, in the host terminal 100, the output form in the output unit 104 is changed on the basis of the bidirectional strength data transmitted from the server 300. Such processing is performed by the host terminal control unit 101 (specifically, the output generation unit 101C). Furthermore, in each of the client terminal 200, the output form in the output unit 204 is changed on the basis of the bidirectional strength data transmitted from the server 300. Such processing is performed by the control unit 201 (specifically, the output generation unit 201C).

Note that, in a case where the attribute information corresponding to the client terminal 200 is already stored in the database 302, the server 300 may receive the ID of the client terminal 200 and read the attribute information corresponding to the ID from the database 302. Furthermore, as described above, when the arrangement information management unit 301A generates the arrangement information, the attribute information is not necessarily used. Furthermore, the generated arrangement information may be transmitted from the server 300 to the host terminal 100 or the client terminals 200. Since the host terminal 100 can change the arrangement position in the arrangement information, it is preferable that the arrangement information is transmitted to at least the host terminal 100. In the host terminal 100, the arrangement information may be displayed or otherwise provided so that the user of the host terminal 100 can recognize the arrangement information.

### (Processing of Changing Arrangement Position of Host Terminal)

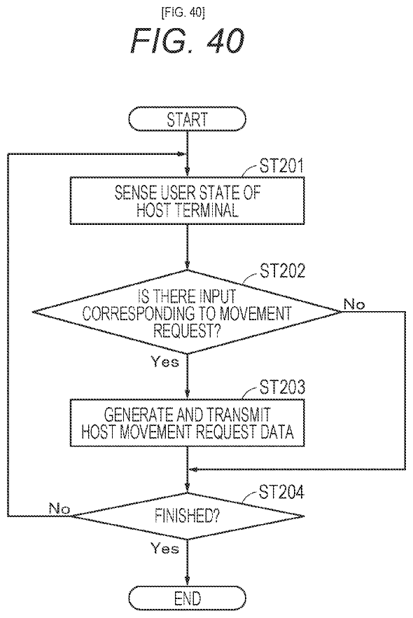

Next, processing of changing the arrangement position of the host terminal 100 (hereinafter, also referred to as host-terminal arrangement position change processing as appropriate) in the arrangement information in response to a request from the host terminal 100 will be described with reference to flowcharts of FIGS. 40 to 43.

FIG. 40 is a flowchart illustrating a flow of processing performed by the host terminal 100 in the host-terminal arrangement position change processing. In step ST201, the input unit 102 senses the user state of the host terminal 100. A sensing result by the input unit 102 is supplied to the host terminal control unit 101. Then, the processing proceeds to step ST202.

In step ST202, the user state determination unit 101B interprets the sensing result by the input unit 102. Then, the user state determination unit 101B determines whether or not there is an input corresponding to the movement request of the host terminal 100. For example, in the arrangement information PIA (see FIG. 9), in a case where the user of the host terminal 100 desires to see the state of “team 4”, the user of the host terminal 100 utters or performs an input operation “How is team 4 doing?”. Such an utterance or the like is detected by the input unit 102. The user state determination unit 101B interprets the utterance content and the operation content of the user of the host terminal 100 to be that the user of the host terminal 100 desires to move to the position of “team 4” in the arrangement information. That is, the user state determination unit 101B determines that there is an input corresponding to the movement request. In this case, the processing proceeds to step ST203. In a case where the user state determination unit 101B determines that there is no input corresponding to the movement request, the processing proceeds to step ST204.

In step ST203, the arrangement information state change instruction unit 101A generates arrangement state change instruction data, specifically, host movement request data. The generated host movement request data is transmitted to the server 300 via the communication unit 103. Then, the processing proceeds to step ST204.

In step ST204, the host terminal control unit 101 determines whether or not a series of processing has been finished. In a case where the processing has not been finished, the processing returns to step ST201, and in a case where the processing has been finished, the processing in the host terminal 100 ends.

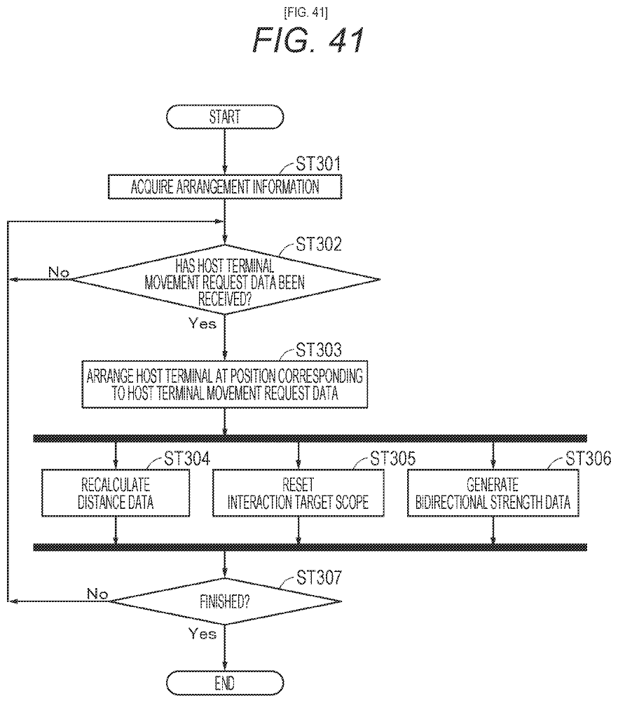

FIG. 41 is a flowchart illustrating a flow of processing performed on the server 300 side subsequent to the processing described with reference to FIG. 40 in the host-terminal arrangement position change processing. In step ST301, the server control unit 301 acquires the arrangement information. For example, the generated arrangement information is read from the database 302. Then, the processing proceeds to step ST302.

In step ST302, the server control unit 301 monitors whether or not host terminal movement request data has been received from the host terminal 100 via the communication unit 303. In a case where the server control unit 301 determines that host terminal movement request data has not been received, the processing of step ST302 is repeated. In a case where the server control unit 301 determines that host terminal movement request data has been received, the processing proceeds to step ST303.

In step ST303, the arrangement information management unit 301A arranges the host terminal 100 at a position corresponding to the host terminal movement request data in the arrangement information.

Subsequent to step ST303, processing of steps ST304 to ST306 is performed. Since the arrangement position of the host terminal 100 in the arrangement information has been changed, the distance data is recalculated (step ST304). Furthermore, since the arrangement position of the host terminal 100 in the arrangement information has been changed, the interaction target scope is reset, and the interaction target scope data is updated (step ST305). The bidirectional strength data is generated again on the basis of the recalculated distance data and the updated interaction target scope data (step ST306). The generated bidirectional strength data is transmitted to each of the host terminal 100 and the client terminals 200 via the communication unit 303. Then, the processing proceeds to step ST307.

In step ST307, the server control unit 301 determines whether or not a series of processing has been finished. In a case where the processing has not been finished, the processing returns to step ST302, and in a case where the processing has been finished, the processing in the server 300 ends.

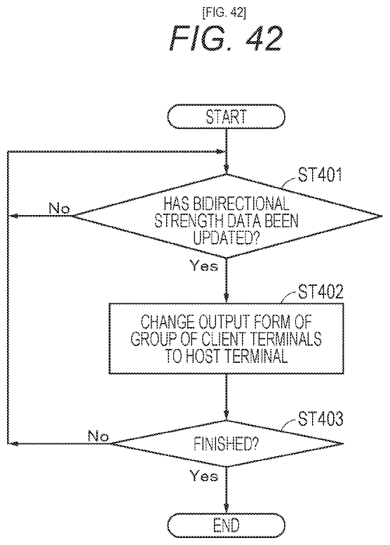

FIG. 42 is a flowchart illustrating a flow of processing performed by the host terminal 100 subsequent to the processing described with reference to FIG. 41 in the host-terminal arrangement position change processing.

In step ST401, the host terminal control unit 101 determines whether or not the bidirectional strength data has been updated. This determination can be made on the basis of whether or not new bidirectional strength data has been received via the communication unit 103. In a case where the bidirectional strength data has not been updated, the processing returns to step ST401. In a case where the bidirectional strength data has been updated, the processing proceeds to step ST402.

In step ST402, the output generation unit 101C changes the output form of the group of the client terminals 200 to the host terminal 100 on the basis of the updated bidirectional strength data. For example, it is assumed that in a case where the arrangement position of the host terminal 100 is the root, the video of all the students who are the users of the client terminals 200 is displayed on the display 104A. It is assumed that the host terminal 100 is moved to the position of the client terminal 200 corresponding to “team 4” according to the host terminal movement data. In this case, the bidirectional strength data is updated such that the bidirectional strength between the host terminal 100 and the client terminal 200 of “team 4” is larger. On the basis of the updated bidirectional strength data, only the students of “team 4” are displayed on the display 104A. Then, the processing proceeds to step ST403.

In step ST403, the host terminal control unit 101 determines whether or not a series of processing has been finished. In a case where the processing has not been finished, the processing returns to step ST401, and in a case where the processing has been finished, the processing in the host terminal 100 ends.

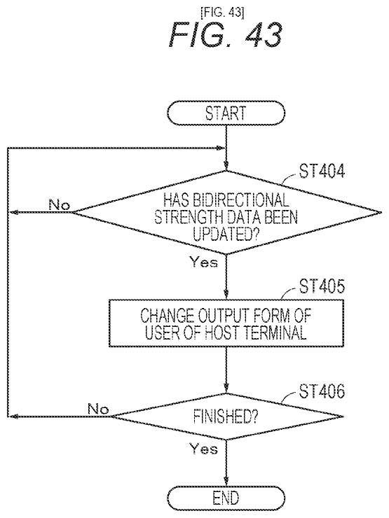

FIG. 43 is a flowchart illustrating a flow of processing performed by the client terminal 200 subsequent to the processing described with reference to FIG. 41 in the host-terminal arrangement position change processing.

In step ST404, the client terminal control unit 201 determines whether or not the bidirectional strength data has been updated. This determination can be made according to whether or not new bidirectional strength data has been received via the communication unit 203. In a case where the bidirectional strength data has not been updated, the processing returns to step ST404. In a case where the bidirectional strength data has been updated, the processing proceeds to step ST405.

In step ST405, the output generation unit 201C changes the output form of the user of the host terminal 100 in the output unit 104 on the basis of the updated bidirectional strength data. The bidirectional strength data before and after the update is compared, and in a case where the bidirectional strength becomes larger, the user of the host terminal 100 is output in a more concrete manner in the output unit 204, and in a case where the bidirectional strength becomes smaller, the user of the host terminal 100 is output in a more abstract manner in the output unit 204. Then, the processing proceeds to step ST406.

In step ST406, the host terminal control unit 101 determines whether or not a series of processing has been finished. In a case where the processing has not been finished, the processing returns to step ST404, and in a case where the processing has been finished, the processing in each of the client terminals 200 ends.

### (Processing in Consideration of Presence or Absence of Change Instruction of Arrangement Information)

As described above, the arrangement information state change instruction data can include not only the host terminal movement request data but also the arrangement information change instruction data. The change instruction of the arrangement information is issued by the host terminal 100, for example.

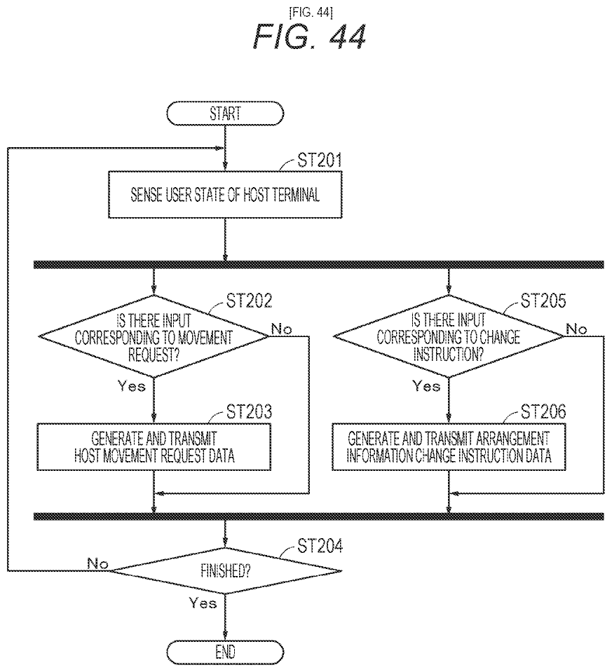

FIG. 44 is a flowchart illustrating a flow of processing in consideration of presence or absence of change instruction of the arrangement information (processing performed by the host terminal 100). Note that processing steps similar to those described above are denoted by the same reference signs, and redundant description will be omitted as appropriate. This is similarly true to other flowcharts.

In parallel with the processing of steps ST202 and ST203 described above (see FIG. 40), the processing of steps ST205 and ST206 is performed. In step ST205, the user state determination unit 101B interprets the sensing result by the input unit 102. Then, the user state determination unit 101B determines whether or not there is an input corresponding to an arrangement information change instruction. For example, the user of the host terminal 100 utters or performs an input operation to tell “Now, let's make groups by residential area instead of team”. Such an utterance or the like is detected by the input unit 102. The user state determination unit 101B interprets the utterance content and the operation content of the user of the host terminal 100 to be that the user of the host terminal 100 has instructed change of the arrangement information. That is, the user state determination unit 101B determines that there is an input corresponding to an arrangement information change instruction. In this case, the processing proceeds to step ST206. In a case where the user state determination unit 101B determines that there is no input corresponding to the movement request, the processing proceeds to step ST204.

In step ST206, the arrangement information state change instruction unit 101A generates arrangement state change instruction data, specifically, arrangement information change instruction data. The generated arrangement information change instruction data is transmitted to the server 300 via the communication unit 103. Then, the processing proceeds to step ST204.

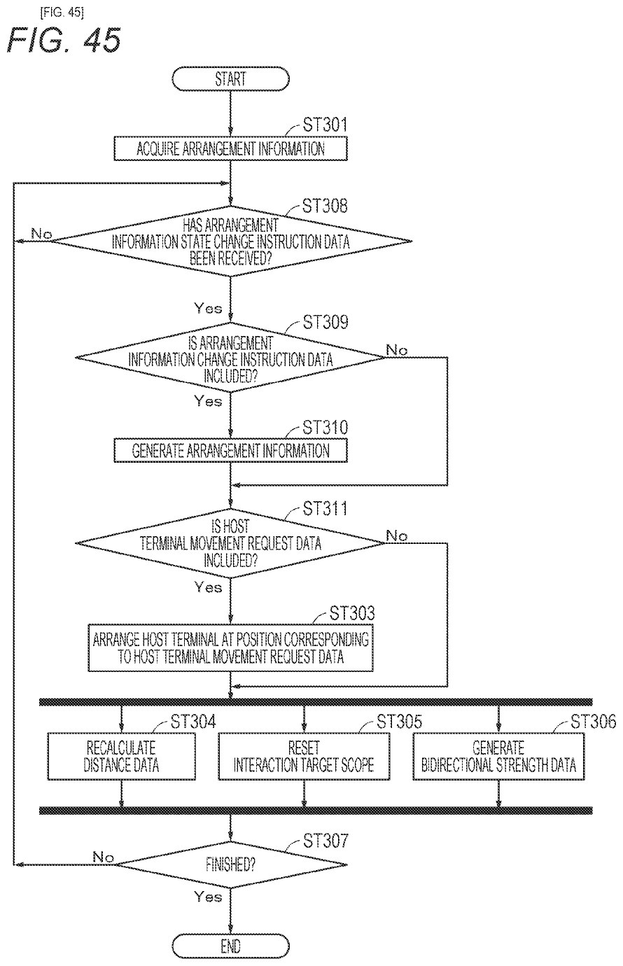

FIG. 45 is a flowchart illustrating a flow of processing in consideration of presence or absence of change instruction of the arrangement information (processing performed by the server 300). In the processing of step ST308 subsequent to step ST301, the server control unit 301 determines whether or not arrangement information state change instruction data has been received. In a case where the server control unit 301 determines that arrangement information state change instruction data has not been received, the processing returns to step ST308. In a case where the server control unit 301 determines that arrangement information state change instruction data has been received, the processing proceeds to step ST309.

In the processing of step ST309, the server control unit 301 determines whether or not arrangement information change instruction data is included in the received arrangement information state change instruction data. In a case where arrangement information change instruction data is not included, the processing proceeds to step ST311. In a case where arrangement information change instruction data is included, the processing proceeds to step ST310.

In step ST310, the arrangement information management unit 301A generates new arrangement information on the basis of the arrangement information change instruction data. For example, the arrangement information management unit 301A generates the arrangement information according to the attribute information included in the arrangement information change instruction data. Then, the processing proceeds to step ST311.

In the processing of step ST311, the server control unit 301 determines whether or not host terminal movement request data is included in the received arrangement information state change instruction data. In a case where host terminal movement request data is not included, the processing proceeds to steps ST304 to ST306. In a case where host terminal movement request data is included, the processing proceeds to step ST303.

Since other processing steps have already been described, redundant description will be omitted. Note that, in a case where it is determined, by the determination processing of step ST311, that host terminal movement request data is included, in the processing of step ST303, the host terminal 100 is arranged at a position specified by the host terminal movement request data in the arrangement information generated in step ST310.

(Processing Related to Response Request from Client Terminal)

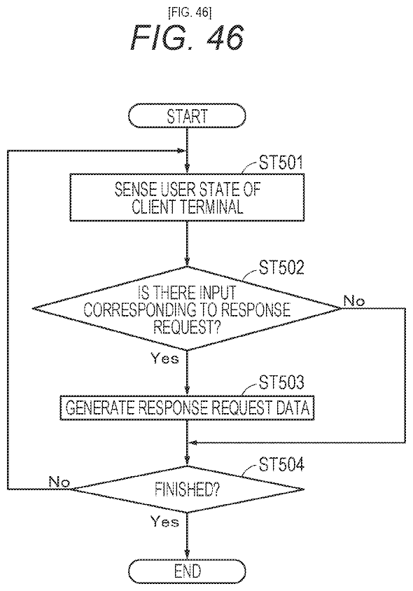

Next, processing related to a response request (hereinafter, it is appropriately referred to as response request processing) from a predetermined client terminal 200 to the host terminal 100 will be described with reference to flowcharts of FIGS. 46 to 48.

FIG. 46 is a flowchart illustrating a flow of processing performed by the client terminal 200 in the response request processing. In step ST501, the input unit 202 senses the user state of the client terminal 200. The sensing result by the input unit 202 is supplied to the client terminal control unit 201, and the processing then proceeds to step ST502.

In step ST502, the user state determination unit 201B interprets the sensing result by the input unit 502. Then, the user state determination unit 201B determines whether or not there is an input corresponding to the response request of the client terminal 200. For example, in a case where an utterance such as “Sir, I have a question.” is detected, the user state determination unit 201B determines that there is an input corresponding to the response request. In this case, the processing proceeds to step ST503. In a case where the user state determination unit 201B determines that there is no input corresponding to the response request, the processing proceeds to step ST504.

In step ST503, the response request generation unit 201A generates response request data. The generated response request data is transmitted to the server 300 via the communication unit 203. Then, the processing proceeds to step ST504.

In step ST504, the client terminal control unit 201 determines whether or not a series of processing has been finished. In a case where the processing has not been finished, the processing returns to step ST502, and in a case where the processing has been finished, the processing in the client terminal 200 ends.

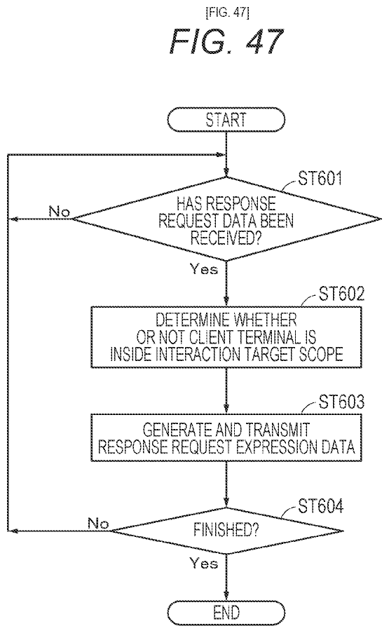

FIG. 47 is a flowchart illustrating a flow of processing performed on the server 300 side subsequent to the processing described with reference to FIG. 46 in the response request processing. In step ST601, the server control unit 301 monitors whether or not response request data has been received from the client terminal 200. In a case where the server control unit 301 determines that response request data has not been received, the processing of step ST601 is repeated. In a case where the server control unit 301 determines that response request data has been received, the processing proceeds to step ST602.

In step ST 602, the server control unit 301 (specifically, the response request expression data generation unit 301C) determines whether or not the client terminal 200 that has transmitted the response request data is inside the interaction target scope referring to the arrangement information. Then, the processing proceeds to step ST603.

In step ST603, the response request expression data generation unit 301C generates response request expression data. In a case where the client terminal 200 that has transmitted the response request data is the client terminal 200 inside the interaction target scope, the response request expression data generation unit 301C generates response request expression data so that the response request is displayed or otherwise provided in a manner in which the user of the host terminal 100 can more easily recognize the response request (for example, the manner illustrated in FIG. 34B). Furthermore, in a case where the client terminal 200 that has transmitted the response request data is the client terminal 200 outside the interaction target scope, the response request expression data generation unit 301C generates response request expression data so that the response request is displayed or otherwise provided in a manner in which the response request is made from a far position (for example, the response request is made from the outside of the display 104A) (for example, the manner illustrated in FIG. 35B). The generated response request expression data is transmitted to the host terminal 100 via the communication unit 303. Then, the processing proceeds to step ST604.

In step ST604, the server control unit 301 determines whether or not a series of processing has been finished. In a case where the processing has not been finished, the processing returns to step ST601, and in a case where the processing has been finished, the processing in the server 300 ends.

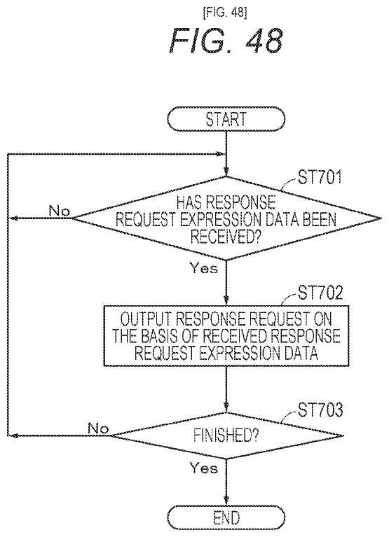

FIG. 48 is a flowchart illustrating a flow of processing performed by the host terminal 100 subsequent to the processing described with reference to FIG. 47 in the response request processing. In step ST701, the host terminal control unit 101 determines whether or not response request expression data has been received via the communication unit 103. In a case where the host terminal control unit 101 determines that response request expression data has not been received, the processing of step ST701 is repeated. In a case where the host terminal control unit 101 determines that the response request expression data has been received, the processing proceeds to step ST702.

In step ST702, the output generation unit 101C outputs the response request by display or sound reproduction in a manner based on the response request expression data. Then, the processing proceeds to step ST703.

In step ST703, the server control unit 301 determines whether or not a series of processing has been finished. In a case where the processing has not been finished, the processing returns to step ST701, and in a case where the processing has been finished, the processing in the server 300 ends.

### Modifications

Although the embodiment of the present disclosure has been specifically described, the present disclosure is not limited to the above-described embodiment, and various modifications based on the technical idea of the present disclosure may be made.

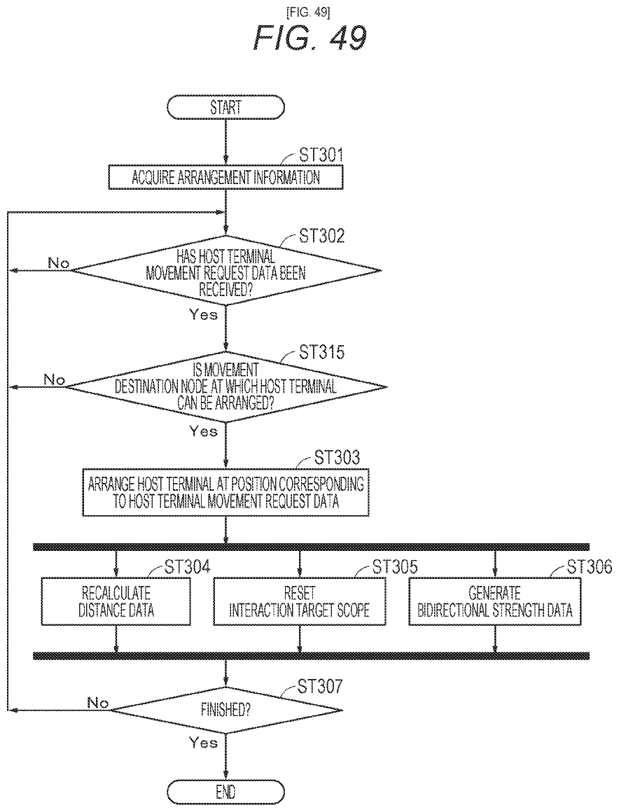

A limitation may be set to nodes at which the host terminal can be arranged (arrangeable range) in the arrangement information. As a result, for example, the distance data between the host terminal and the client terminals can be made equal to or more than a certain value. Since the distance data can be set to a certain value or more, the display or the like of the users of the client terminals can be made abstract to a certain extent or more. For example, it is possible to prevent the face of the users of the client terminals from becoming clear beyond a certain level. Therefore, it is possible to protect the privacy of the user of the client terminal. In this case, as illustrated in FIG. 49, in the flowchart illustrated in FIG. 41, after step ST302, processing of step ST315 is performed. In step ST315, it is determined whether or not the movement destination corresponding to the host terminal movement request data is a node at which the host terminal can be arranged. In a case where the host terminal can be arranged at the node, the processing proceeds to step ST303, and in a case where the host terminal cannot be arranged at the node, the processing returns to step ST302.

The above-described embodiment has been described using a display and a speaker as an example of the output unit, but the present invention is not limited thereto. The output unit may be, for example, a device that gives a tactile sense (vibration, stiffness, thermal sensation, texture, and the like) to the user or a device that gives a smell to the user. For example, control may be performed such that in a case where the bidirectional strength is large, the vibration becomes large or the smell becomes strong.

In the above-described embodiment, an example in which the bidirectional strength data is generated on the basis of the distance data and the interaction target scope data has been described, but the bidirectional strength data may be generated on the basis of either one of the distance data and the interaction target scope data.

In the above-described embodiment, an example mainly applied to a remote lesson system has been described, but the present invention can also be applied to live distribution or the like. For example, in a system that distributes live show video to the whole world, when an artist calls out “Asians”, arrangement information according to the region is generated, and distance data between client terminals of Asians and the host terminal (terminal on the artist side) becomes small. As a result, it is possible to perform control such that video in which the artist is large is displayed and the artist's voice is heard loudly on the client terminals of Asians.

In the above-described embodiment, in a case where the arrangement information is changed, the interaction target scope may be changed. The definition of the interaction target scope (for example, a range of one level below the host terminal) may be changed.

Furthermore, control may be performed such that not all but only a part of the arrangement information (for example, levels lower than a predetermined level) is changed.

In the above-described embodiment, an example in which processing is performed via a server has been described, but there may be no server. In this case, a host terminal or a predetermined client terminal may function as a server.

Furthermore, the server may acquire information regarding the bidirectional strength, and perform control to change the output form in the output unit of at least one information processing terminal (for example, a host terminal or a client terminal) among the plurality of information processing terminals on the basis of the bidirectional strength. For example, the server generates control data for changing the output form on the basis of the bidirectional strength, and transmits the generated control data to the host terminal or the client terminal. The host terminal or the client terminal performs control according to the control data, so that the output form in the output unit is changed. Note that, in order for the server to acquire the information regarding the bidirectional strength, the server may acquire the information regarding the bidirectional strength from another server, or may generate itself the information regarding the bidirectional strength on the basis of the arrangement information to acquire the information.

Furthermore, one or a plurality of arbitrarily selected aspects of the above-described embodiments and modifications can be appropriately combined.

Furthermore, the configurations, methods, steps, shapes, materials, numerical values, and the like of the above-described embodiments can be combined with each other without departing from the gist of the present disclosure.

Note that the present disclosure can also have the following configurations.

(1)

An information processing device including
a control unit configured to acquire information regarding a bidirectional strength based on arrangement information indicating a relationship between a plurality of information processing terminals, and perform control to change an output form in an output unit of at least one information processing terminal among the plurality of information processing terminals on the basis of the bidirectional strength.
   (2)

The information processing device according to (1), in which
the bidirectional strength data includes distance data indicating a distance to a predetermined information processing terminal in the arrangement information, and
the control unit performs control to change an output form of the output unit according to the distance data.
   (3)

The information processing device according to (2), in which
the control unit performs control to change an output form of the output unit such that information corresponding to the information processing terminal is expressed in a more abstract manner as the distance data is larger, and performs control to change an output form of the output unit such that information corresponding to the information processing terminal is expressed in a more concrete manner as the distance data is smaller.
   (4)

The information processing device according to (2), in which
the bidirectional strength data includes interaction target scope data indicating whether or not the predetermined information processing terminal is included in an interaction target scope that is a range in which interaction via the output unit is possible, in the arrangement information, and
the control unit performs control to change an output form of the output unit according to the distance data and the interaction target scope data.
   (5)

The information processing device according to (4), in which
the control unit performs control to change an output form of the output unit such that information corresponding to the predetermined information processing terminal is expressed in an abstract manner in a case where the predetermined information processing terminal is not included in the interaction target scope, and performs control to change an output form of the output unit such that information corresponding to the predetermined information processing terminal is expressed in a concrete manner in a case where the predetermined information processing terminal is included in the interaction target scope.
   (6)

The information processing device according to (4) or (5), in which
the interaction target scope is set on the basis of the distance data.
   (7)

The information processing device according to (2), in which
the predetermined information processing terminal includes a host terminal arranged in the arrangement information.
   (8)

The information processing device according to (7), in which
an arrangement position of the host terminal defined by the arrangement information is changeable.
   (9)

The information processing device according to (8), in which
the bidirectional strength data is reset according to change in an arrangement position of the host terminal.
   (10)

The information processing device according to (8) or (9), in which
an arrangeable range of the host terminal in the arrangement information is set.
   (11)

The information processing device according to any one of (7) to (10), in which
the control unit transmits a response request to the host terminal via a communication unit, and
the response request is transmitted to the host terminal on the basis of the arrangement information.
   (12)

The information processing device according to (4), in which
the predetermined information processing terminal includes a client terminal, and
the output unit outputs information corresponding to a response request from the client terminal, and
the control unit performs control to change an output form of the information corresponding to the response request on the basis of the interaction target scope data.
   (13)

The information processing device according to (12), in which
the control unit performs control to output the information corresponding to the response request in different output forms on the basis of whether or not the client terminal is included in the interaction target scope.
   (14)

The information processing device according to any one of (1) to (13), in which
the arrangement information is defined according to attribute information input from each information processing terminal.
   (15)

The information processing device according to any one of (1) to (14), in which
the arrangement information is changeable.
   (16)

The information processing device according to (15), in which
the arrangement information is changed in response to a change request of a host terminal in the arrangement information.
   (17)

The information processing device according to any one of (1) to (16), in which
the output unit includes a device that displays video, and
the control unit changes an output form of the video.
   (18)

The information processing device according to any one of (1) to (17), in which
the output unit includes a device that reproduces voice, and
the control unit changes an output form of the voice.
   (19)

An information processing method including
acquiring, by a control unit, information regarding a bidirectional strength based on arrangement information indicating a relationship between a plurality of information processing terminals, and performing control to change an output form in an output unit of at least one information processing terminal among the plurality of information processing terminals on the basis of the bidirectional strength.
   (20)

A program causing a computer to perform an information processing method including
acquiring, by a control unit, information regarding a bidirectional strength based on arrangement information indicating a relationship between a plurality of information processing terminals, and performing control to change an output form in an output unit of at least one information processing terminal among the plurality of information processing terminals on the basis of the bidirectional strength.

### REFERENCE SIGNS LIST

11A, 100 Host terminal
11B to 11E, 200 Client terminal
300 Server
101 Host terminal control unit
101C Output generation unit
103 Communication unit
104 Output unit
201 Client terminal control unit
201C Output generation unit
203 Communication unit
204 Output unit
301 Server control unit

1. An information processing device comprising a control unit configured to acquire information regarding a bidirectional strength based on arrangement information indicating a relationship between a plurality of information processing terminals, and perform control to change an output form in an output unit of at least one information processing terminal among the plurality of information processing terminals on a basis of the bidirectional strength.

2. The information processing device according to claim 1, wherein
the bidirectional strength data includes distance data indicating a distance to a predetermined information processing terminal in the arrangement information, and
the control unit performs control to change an output form of the output unit according to the distance data.

3. The information processing device according claim 2, wherein
the control unit performs control to change an output form of the output unit such that information corresponding to the information processing terminal is expressed in a more abstract manner as the distance data is larger, and performs control to change an output form of the output unit such that information corresponding to the information processing terminal is expressed in a more concrete manner as the distance data is smaller.

4. The information processing device according to claim 2, wherein
the bidirectional strength data includes interaction target scope data indicating whether or not the predetermined information processing terminal is included in an interaction target scope that is a range in which interaction via the output unit is possible, in the arrangement information, and
the control unit performs control to change an output form of the output unit according to the distance data and the interaction target scope data.

5. The information processing device according to claim 4, wherein
the control unit performs control to change an output form of the output unit such that information corresponding to the predetermined information processing terminal is expressed in an abstract manner in a case where the predetermined information processing terminal is not included in the interaction target scope, and performs control to change an output form of the output unit such that information corresponding to the predetermined information processing terminal is expressed in a concrete manner in a case where the predetermined information processing terminal is included in the interaction target scope.

6. The information processing device according to claim 4, wherein
the interaction target scope is set on a basis of the distance data.

7. The information processing device according to claim 2, wherein
the predetermined information processing terminal includes a host terminal arranged in the arrangement information.

8. The information processing device according to claim 7, wherein
an arrangement position of the host terminal defined by the arrangement information is changeable.

9. The information processing device according to claim 8, wherein
the bidirectional strength data is reset according to change in an arrangement position of the host terminal.

10. The information processing device according to claim 8, wherein
an arrangeable range of the host terminal in the arrangement information is set.

11. The information processing device according to claim 7, wherein
the control unit transmits a response request to the host terminal via a communication unit, and
the response request is transmitted to the host terminal on a basis of the arrangement information.

12. The information processing device according to claim 4, wherein
the predetermined information processing terminal includes a client terminal, and
the output unit outputs information corresponding to a response request from the client terminal, and
the control unit performs control to change an output form of the information corresponding to the response request on a basis of the interaction target scope data.

13. The information processing device according to claim 12, wherein
the control unit performs control to output the information corresponding to the response request in different output forms on a basis of whether or not the client terminal is included in the interaction target scope.

14. The information processing device according to claim 1, wherein
the arrangement information is defined according to attribute information input from each information processing terminal.

15. The information processing device according to claim 1, wherein
the arrangement information is changeable.

16. The information processing device according to claim 15, wherein
the arrangement information is changed in response to a change request of a host terminal in the arrangement information.

17. The information processing device according to claim 1, wherein
the output unit includes a device that displays video, and
the control unit changes an output form of the video.

18. The information processing device according to claim 1, wherein
the output unit includes a device that reproduces voice, and
the control unit changes an output form of the voice.

19. An information processing method comprising
acquiring, by a control unit, information regarding a bidirectional strength based on arrangement information indicating a relationship between a plurality of information processing terminals, and performing control to change an output form in an output unit of at least one information processing terminal among the plurality of information processing terminals on a basis of the bidirectional strength.

20. A program causing a computer to perform an information processing method comprising
acquiring, by a control unit, information regarding a bidirectional strength based on arrangement information indicating a relationship between a plurality of information processing terminals, and performing control to change an output form in an output unit of at least one information processing terminal among the plurality of information processing terminals on a basis of the bidirectional strength.
